(19) United States
(12) Patent Application Publication
(10) Pub. No.: US 2023/0316399 A1
(43) Pub. Date: Oct. 5, 2023

(54) Electronic Trading System and Method based on Point-to-Point Mesh Architecture

(71) Applicant: Hyannis Port Research, Inc., Needham, MA (US)

(72) Inventors: Anthony D. Amicangioli, Newton, MA (US); Allen Bast, Sharon, MA (US); B. Joshua Rosen, Westford, MA (US); Christophe Juhasz, Carlisle, MA (US)

(21) Appl. No.: 18/040,805

(22) PCT Filed: Aug. 5, 2021
(86) PCT No.: PCT/US2021/044754

§ 371 Date: Feb. 6, 2023

Related U.S. Application Data
(63) Continuation-in-part of application No. 16/988,510, filed on Aug. 7, 2020, now Pat. No. 11,315,183.
Application No. 16/988,510 is a continuation-in-part of application No. 16/988,491, filed on Aug. 7, 2020, now Pat. No. 11,328,357.

(51) Int. Cl. G06Q 40/04; G06F 11/20

(52) U.S. Cl. CPC G06Q 40/04; G06F 11/2028

(57) ABSTRACT

An electronic trading system and corresponding method are based on a point-to-point mesh architecture. The electronic trading system comprises a gateway, core compute node, and sequencer. The core compute node performs an electronic trading matching function. The gateway transmits a message to the core compute node via a first direct connection. The gateway transmits the message via a second direct connection to the sequencer which, in turn, transmits a sequence-marked message to the core compute node via a third direct connection. The core compute node determines relative ordering of the message among other messages in the electronic trading system based on the sequence-marked message to complete the electronic trading matching function, deterministically. The gateway, core compute node, sequencer, and respective direct connections form at least a portion of the point-to-point mesh architecture and enable the electronic trading system to perform high-speed, deterministic, electronic trading of financial instruments while exhibiting low latency, fairness, and fault tolerance, among other features.

### RELATED APPLICATIONS

This application is a continuation-in-part of U.S. application Ser. No. 16/988,510, filed Aug. 7, 2020, and a continuation-in-part of U.S. application Ser. No. 16/988,491, filed Aug. 7, 2020. The entire teachings of the above applications are incorporated herein by reference.

### BACKGROUND

Current financial instrument trading systems allow traders to submit orders and receive confirmations, market data, and other information, electronically, via a communications network. Such “electronic” marketplaces, implemented by, and also referred to as, “electronic trading systems,” are the predominant means of trading most financial instruments, having largely replaced pit-based “open outcry” trading systems whereby the traders, or their representatives, all physically stood in a designated location, i.e., a trading pit, and traded with each other via oral and visual/hand based communication.

When trading shares and/or other financial instruments in an electronic trading system, the electronic trading system is generally configured to match trade orders, i.e., bid orders and compatible ask orders, to create a trade. Depending on the conditions associated with the trade, the processes of matching bid and ask orders can sometimes be complex.

An example of an electronic trading system is a computerized exchange that comprises a central matching engine, typically residing within a central server, and a plurality of distributed servers, or gateways. In such a computerized exchange, the typical process can be as follows: order entry messages, e.g., bid orders and/or ask orders are sent from client or participant devices, e.g., trader terminals, to the computerized exchange and the computerized exchange processes the order entry messages. Such order entry messages are received via the gateways at the central server. The processing in the computerized exchange, e.g., at the central server, may include, among other things, performing order matching based on the received order entry messages.

An order processing acknowledgement message generated by the central server, is then typically returned to the participant devices via the gateway that forwarded the transaction. The gateway may perform additional processing before the order processing acknowledgement message is returned to the participant device. The central server may also disseminate information relating to the order processing acknowledgement message, either in the same form as received or otherwise, to one or more other gateways which perform processing of the order processing acknowledgement message to generate market data output over a market data stream. The market data output is typically forwarded to participant devices or other subscribers of the market data stream through a variety of communication mechanisms, requiring additional processing in the gateways.

### SUMMARY

According to an example embodiment, an electronic trading system comprises a gateway, a core compute node (also referred to interchangeably herein as a core compute engine or compute engine) configured to perform an electronic trading matching function, and a sequencer. The gateway and core compute node are coupled via a first direct connection. The gateway and sequencer are coupled via a second direct connection. The sequencer and core compute node are coupled via a third direct connection. The first, second, and third direct connections have respective non-shared bandwidths. The gateway is configured to transmit a message, representing an electronic trade request with an offer to buy or sell a financial instrument, to the core compute node via the first direct connection. The message is received, in turn, by the core compute node. The gateway is further configured to transmit the message via the second direct connection to the sequencer which is configured to, in turn, transmit a sequence-marked message to the core compute node via the third direct connection. The sequencer is interposed between the gateway and core compute node via the second and third direct connections. The sequence-marked message transmitted by the sequencer is a sequenced version of the message transmitted by the gateway. The sequence-marked message is received, in turn, by the core compute node. The core compute node is configured to determine relative ordering (i.e., sequence) of the sequence-marked message among sequence-marked versions of other messages received by the core compute node in the electronic trading system. The core compute node is further configured to complete the electronic trading matching function for the electronic trade request in accordance with the relative ordering determined, causing the offer to be matched with a counteroffer for the financial instrument enabling an electronic trade of the financial instrument.

The message and the sequence-marked message may include identical user data. The user data is associated with the electronic trade request.

The message may be a gateway message transmitted by the gateway in response to receipt of an incoming message received by the gateway from a participant device. The sequencer is further configured to, in turn, transmit the sequence-marked message via the second direct connection to the gateway. The sequence-marked message is received, in turn, by the gateway. The sequence-marked message is a first sequence-marked message. The core compute node is further configured to transmit a core compute node message via the first direct connection to the gateway in response to receiving the gateway message. The core compute node is further configured to transmit the core compute node message via the third direct connection to the sequencer which is further configured to, in turn, transmit a second sequence-marked message via the second direct connection to the gateway. The second sequence-marked message is a sequenced version of the core compute node message. The gateway is further configured to determine relative ordering of the second sequence-marked message and sequence-marked versions of other messages sent from the core compute node to the gateway. The gateway is further configured to transmit an outgoing message to the participant device. The outgoing message is transmitted in accordance with the relative ordering determined. The sequencer is further configured to, in turn, transmit the second sequence-marked message via the third direct connection to the core compute node.

The gateway may be a given gateway among a plurality of gateways. The core compute node may be a given core compute node among a plurality of core compute nodes. Each gateway of the plurality of gateways may be coupled to each core compute node of the plurality of core compute nodes via respective first direct connections. The sequencer may be coupled to each gateway of the plurality of gateways via respective second direct connections and coupled to each core compute node of the plurality of core compute nodes via respective third direct connections. The plurality of gateways, plurality of core compute nodes, sequencer, and respective direct connections may form at least a portion of a point-to-point mesh system.

Within the point-to-point mesh system, each gateway of the plurality of gateways may be configured to transmit a respective compute-node-destined message transmitted therefrom to all compute nodes of the plurality of core compute nodes and to the sequencer. It should be understood that a message that is destined for compute node may be referred to interchangeably herein as a “compute-node-destined” message. Further, a message that is destined for a gateway may be referred to interchangeably herein as a “gateway-destined” message. Each core compute node of the plurality of core compute nodes may be configured to transmit a respective gateway-destined message transmitted therefrom to all gateways of the plurality of gateways and to the sequencer. The sequencer may be further configured to transmit, to the plurality of gateways and plurality of core compute nodes, a respective sequence-marked message in response to receipt of the respective compute-node-destined message or the respective gateway-destined message.

The sequencer may be a given sequencer of a plurality of sequencers in the point-to-point mesh system. Each gateway of the plurality of gateways may be coupled to each sequencer of the plurality of sequencers via respective second direct connections. Each core compute node of the plurality of core compute nodes may be coupled to each sequencer of the plurality of sequencers via respective third direct connections. The given sequencer may be a currently active sequencer servicing the point-to-point mesh system and each other sequencer of the plurality of sequencers may be standby sequencers waiting to take over as the currently active sequencer. Each sequencer of the plurality of sequencers may be coupled to each other sequencer of the plurality of sequencers via a respective fourth direct connection. Each gateway of the plurality of gateways may be further configured to transmit a respective compute-node-destined message to the given sequencer of the plurality of sequencers. Each core compute node of the plurality of core compute nodes may be further configured to transmit a respective gateway-destined message to the given sequencer of the plurality of sequencers. The given sequencer may be further configured to transmit the sequence-marked message via each respective fourth direct connection to each other sequencer of the plurality of sequencers to enable the standby sequencers to be able to take over as the currently active sequencer in an event the currently active sequencer fails.

The respective compute-node-destined message transmitted by the given gateway may be a same message received by the plurality of core compute nodes. The plurality of core compute nodes may be configured to generate response messages in response to receipt of the same message. The response messages may be received at the given gateway from among the plurality of core compute nodes. The given gateway may be further configured to take action based on a given response message of the response messages generated in response to receipt of the same message. The given response message may be first to arrive at the given gateway relative to other response messages generated in response to receipt of the same message. The gateway may be further configured to ignore the other response messages that arrive after the given response message.

A plurality of compute-node-destined messages representing a same message may be received from among the plurality of gateways at the given compute node. The given compute node may be further configured to take action based on a given compute-node-destined message of the plurality of compute-node destined messages. The given compute-node-destined message may be first to arrive at the given compute node relative to other compute-node-destined messages of the plurality of compute-node-messages representing the same message. The given core compute node may be further configured to ignore the other compute-node-destined messages that arrive after the given compute-node-destined message.

The electronic trading system may further comprise an order book accessible by the core compute node. The core compute node may be further configured to match trade orders related to the financial instrument using the electronic trading matching function. The core compute node may be further configured to maintain a residual position of the financial instrument on the order book. An unmatched amount of the financial instrument may result from performing the electronic trading matching function. The residual position may include the unmatched amount of the financial instrument. It should be understood that the residual position can convey more information than quantity. For example, a position can be long and short (side). According to an example embodiment, the residual position conveys both price and quantity.

The electronic trading system may further comprise a clock. The gateway, core compute node, and sequencer, may be synchronized based on the clock.

The gateway may be further configured to serve at least one participant device and transmit the message to the sequencer and core compute node in response to receipt of an incoming message at the gateway. The incoming message may be sourced by the at least one participant device. The sequencer may be further configured to produce the sequence-marked message by marking the message with a unique sequence identifier or by creating a representation of the message received, marking the representation with the unique sequence identifier, and transmitting the representation marked. The representation marked may be the sequence-marked message.

The electronic trading system may further comprise at least one respective redundant direct connection for the first direct connection, second direct connection, and third direct connection, or a subset thereof.

The gateway may be a given gateway of a plurality of gateways communicatively coupled to each other via a shared gateway network. The core compute node may be a given core compute node of a plurality of core compute nodes communicatively coupled to each other via a shared core compute node network. The sequencer may be a given sequencer of a plurality of sequencers communicatively coupled to each other via a shared sequencer network or via respective fourth direct connections.

The electronic trading system may further comprise a system state log. The given sequencer may be configured to transmit the system state log via the shared sequencer network to at least one other sequencer of the plurality of sequencers or store the system state log in a data store. The data store may be accessible to the plurality of sequencers via the shared sequencer network.

The electronic trading system may be an active electronic trading system and at least one sequencer of the plurality of sequencers may be communicatively coupled to a disaster recovery site. The disaster recovery site may include a standby electronic trading system. The standby electronic trading system may be a replica of the active electronic trading system and may be configured to allow electronic trading to continue in an event the active electronic trading system fails.

The gateway, core compute node, sequencer, and first, second, and third direct connections may form a first point-to-point mesh system. The electronic trading system may be a first electronic trading system communicatively coupled to a proxy node. The proxy node may be further communicatively coupled to at least one participant device and a second electronic trading system. The second electronic trading system may include a second point-to-point mesh system. The proxy node may be configured to transmit a message to the first and second electronic trading systems in response to receipt of an incoming message from the at least one participant device. The first and second electronic trading systems may be configured to generate respective responses to the message transmitted by the proxy node. The proxy node may be further configured to send a response to the at least one participant device in response to receipt of a first arriving response of the respective responses generated and received from the first or second electronic trading systems.

According to another example embodiment, a method for performing electronic trading comprises transmitting a message, representing an electronic trade request with an offer to buy or sell a financial instrument, via a first direct connection from a gateway to a core compute node. The method further comprises receiving the message, in turn, at the core compute node for performing an electronic trading function in an electronic trading system. The method further comprises transmitting the message via a second direct connection from the gateway to a sequencer in the electronic trading system and, in turn, transmitting a sequence-marked message via a third direct connection from the sequencer to the core compute node. The first, second, and third direct connections have respective non-shared bandwidths. The sequencer is interposed between the gateway and core compute node via the second and third direct connections. The sequence-marked message transmitted by the sequencer is a sequenced version of the message transmitted from the gateway via the second direct connection. The method further comprises receiving the sequence-marked message, in turn, at the core compute node. The method further comprises receiving, at the core compute node, other messages from the gateway and receiving, at the core compute node, sequence-marked versions of the other messages from the sequencer. The method further comprises determining, at the core compute node, relative ordering of the sequence-marked message among the sequence-marked versions of the other messages received by the core compute node in the electronic trading system. The method further comprises completing, at the core compute node, the electronic trading matching function for the electronic trade request in accordance with the relative ordering determined, the completing causing the offer to be matched with a counteroffer for the financial instrument enabling an electronic trade of the financial instrument.

Alternative method embodiments parallel those described above in connection with the example electronic trading system embodiment.

According to another example embodiment, a sequencer of an electronic trading system comprises a non-transitory computer-readable medium having encoded thereon a sequence of instructions which, when loaded and executed by the sequencer, causes the sequencer to communicate directly with a gateway via a first direct connection in a point-to-point mesh system of the electronic trading system. The sequence of instructions further causes the sequencer to communicate directly with a core compute node via a second direct connection in the point-to-point mesh system of the electronic trading system. The sequencer is interposed between the gateway and core compute node via the first and second direct connections. The first and second direct connections have respective non-shared bandwidths. The sequence of instructions further causes the sequencer to produce a sequence-marked message by marking a message, or representation thereof, with a unique sequence identifier, the message received by the sequencer via the first or second direct connection, respectively. The sequence of instructions further causes the sequencer to transmit the sequence-marked message to the gateway and core compute node.

According to another example embodiment, an electronic trading system comprises a gateway coupled to a core compute node via an activation link and an ordering path and a sequencer electronically disposed within the ordering path. The gateway is configured to transmit a message to the core compute node via the activation link and the ordering path. The core compute node is configured to receive the message and a sequence-marked version of the message from the gateway and sequencer, respectively. The sequence-marked version includes a sequence identifier indicating a deterministic position of the message among a plurality of messages communicated via the activation link and received by the sequencer via the ordering path. The message and sequence-marked version include common metadata.

The core compute node may be configured to (i) commence a matching function activity for an electronic trade responsive to receipt of the message via the activation link, and (ii) responsive to receipt of the sequence-marked version via the ordering path, use the sequence identifier to prioritize completion of the matching function activity toward servicing the electronic trade.

The message and sequence-marked version may include common metadata. The core compute node may be further configured to correlate the message with the sequence-marked version based on the common metadata, responsive to receipt of the sequence-marked version via the ordering path.

According to yet another example embodiment, an electronic trading system may comprise a gateway, sequencer, and core compute node arranged in a point-to-point mesh topology. The core compute node may be configured to perform a matching function toward servicing trade requests received from participant devices and introduced into the point-to-point mesh topology via the gateway. The point-to-point mesh topology may include a first direct connection, second direct connection, and third direction connection. The sequencer may be configured to (i) determine a deterministic order (i.e., sequence) for messages communicated between the gateway and core compute node via the first direct connection and received by the sequencer from the gateway or core compute node via the second or third direct connection, respectively. The sequencer may be further configured to (ii) convey position of the messages within the deterministic order by transmitting sequence-marked versions of the messages to the gateway and core compute node via the second and third direct connections, respectively, the messages representing the trade requests or responses thereto.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of market for trading financial instruments.

FIG. 1B-1 is a block diagram of an example embodiment of an electronic trading system.

FIG. 1B-2 is a block diagram of an example embodiment of another electronic trading system.

FIG. 1C is a block diagram of an example embodiment of a point-to-point mesh system.

FIG. 1D is a block diagram of another example embodiment of an electronic trading system.

FIG. 1E is a table of an example embodiment of fields of a message format for trading messages.

FIG. 1F is a flow diagram illustrating an example embodiment of operation of an electronic trading system.

FIG. 1G is a flow diagram illustrating another example embodiment of operation of an electronic trading system.

FIG. 2 is a block diagram of an example embodiment of a mesh node in a point-to-point mesh architecture of an electronic trading system.

FIG. 3 is a block diagram of another example embodiment of a point-to-point mesh system.

FIG. 4 is a block diagram of another example embodiment of a point-to-point mesh system.

FIG. 5 is a flow diagram of an example embodiment of a method for performing electronic trading.

FIG. 6 is a block diagram of an example embodiment of a sequencer of an electronic trading system.

FIG. 7 is a block diagram of another example embodiment of an electronic trading system.

### DETAILED DESCRIPTION

A description of example embodiments follows.

It should be understood that a dedicated/direct connection disclosed herein is a point-to-point connection that does not go through a shared network switch.

Current electronic trading systems attempt to offer performance advantages; however, many suffer a performance degradation due to increasing transaction volumes from an increasing number of market participants. Implementation by some market participants is often based on high frequency trading methodologies whereby high-speed computers automatically monitor markets and react, usually in an overwhelming manner, to market events. Further, there is continued demand for ever-decreasing processing latencies and response times, driving a need for additional capacity and performance improvements to maintain performance as experienced by each market participant and to avoid detrimental consequences, such as capacity exhaustion and inequitable access.

The increasing speed at which market participants may evaluate and respond to changes in market data, such as responsive to a market event, is increasing the rate at which transactions are received by electronic trading systems, narrowing the time of receipt gap therebetween and necessitating a need for a higher degree of discrimination so as to resolve the order (i.e., sequence) in which those transactions are received, upon which the deterministic operation of the electronic trading system may be based, e.g., for trade order allocation, etc. Furthermore, the addition of channels of communication to electronic trading systems, in an effort to increase capacity and opportunity, along with increased bandwidth of each channel, allows for more transactions to be submitted over multiple parallel paths into the electronic trading system.

Accordingly, it is useful for the electronic trading system to discriminate among closely received incoming transactions. It is further useful for such a system to arbitrate among transactions received simultaneously, or temporally so close together as to be considered simultaneously received. In addition to increased capacity and lower latency, the global nature of business has further driven a need for fault tolerance to increase availability and reliability of electronic trading systems.

A business transaction may be defined as one or more operations or acts which are undertaken according to one or more associated business rules (including industry, legal or regulatory requirements or customs) to accomplish a business or commercial purpose, which may include compliance with industry, regulatory or legal requirements. A business transaction may be implemented by one or more computer processing and/or database operations/program actions, which themselves may be referred to as transactions. Business transactions, as defined by the associated business rules, may be characterized as deterministic in that they may be characterized by an interdependency or relationship which affects their result, such as a dependency on the order (i.e., sequence) in which they are processed, such as a temporal order, and/or a dependency on real time processing, as defined by business rules, so as to effect the business/commercial purpose and/or meet participant expectations, referred to herein as “transactional determinism.” Generally, a set of deterministic transactions will provide a particular result when executed in one order (i.e., sequence) and a different result when executed in a different order (i.e., sequence). In some applications, deterministic processing may be preferred/prioritized over real-time processing.

It is useful for high performance electronic trading systems to assure transactional determinism under increasing loads, while providing improved trading opportunities, fault tolerance, low-latency processing, high volume capacity (e.g., process high numbers of messages per second), minimal impact risk mitigation and market protections, as well as equitable access to information and opportunities.

Example embodiments disclosed herein relate to a high-speed electronic trading system that provides a market where orders to buy and sell financial instruments, such as stocks, bonds, commodities, futures, options, and the like, are traded among market participants, such as traders and brokers. An example embodiment of an electronic trading system disclosed herein exhibits low latency, fairness, fault tolerance, and other features more fully described below.

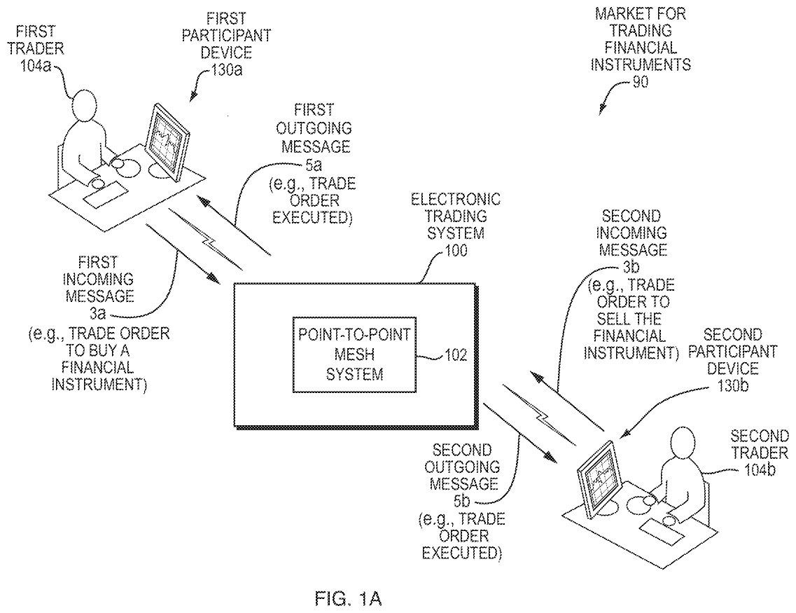

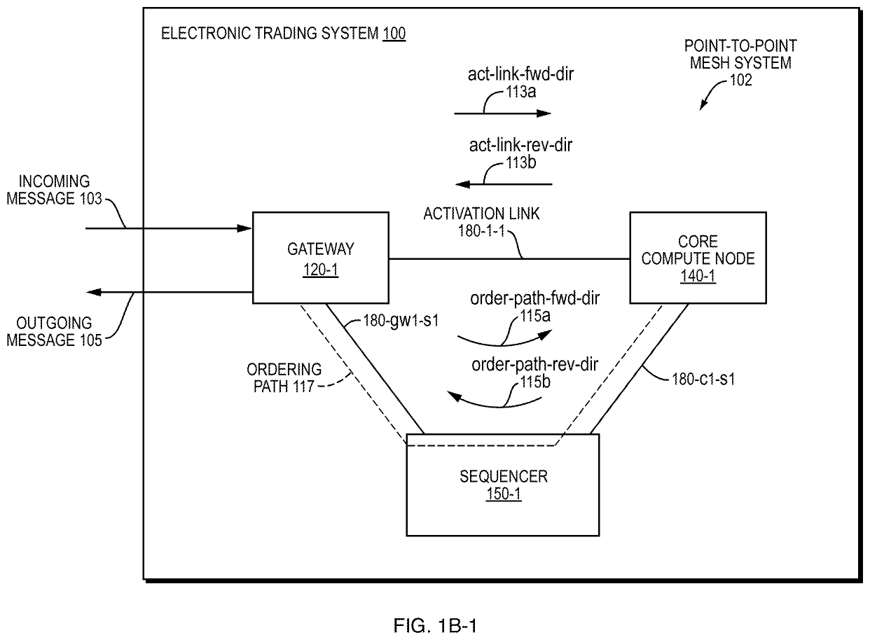

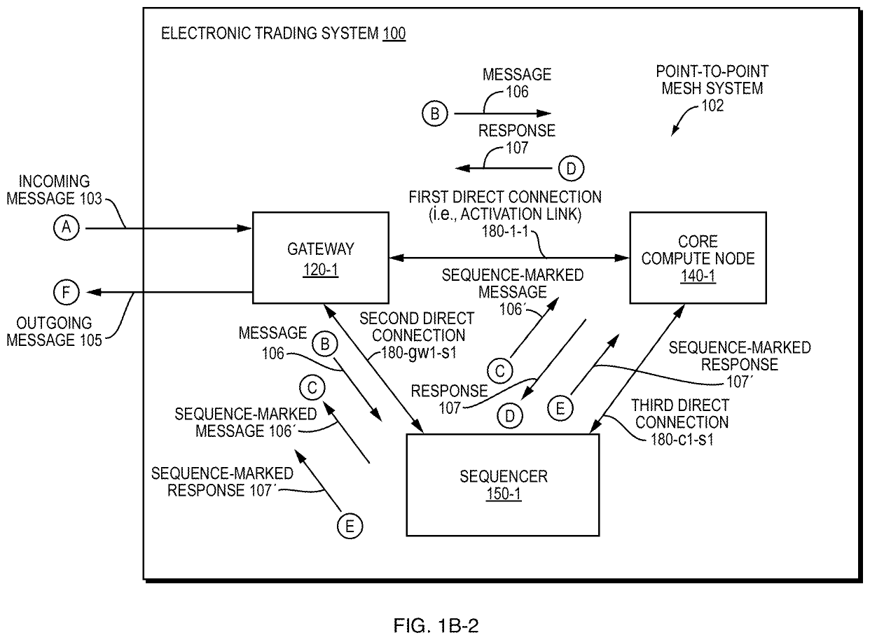

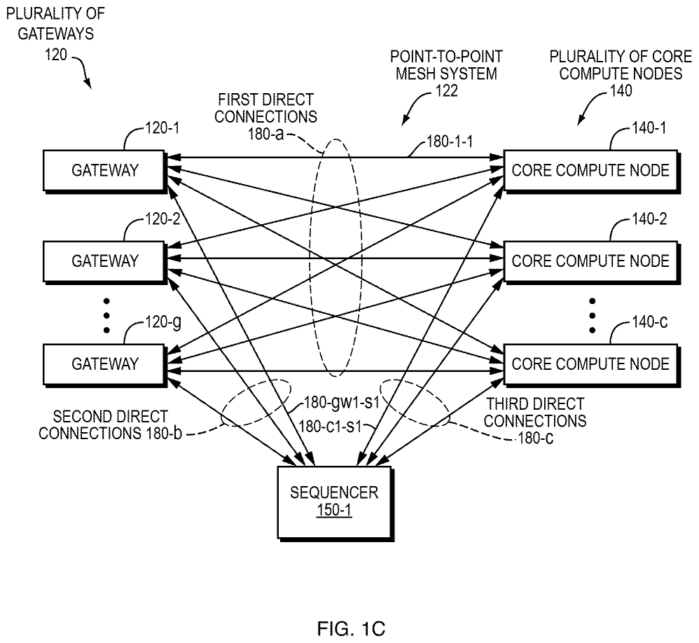

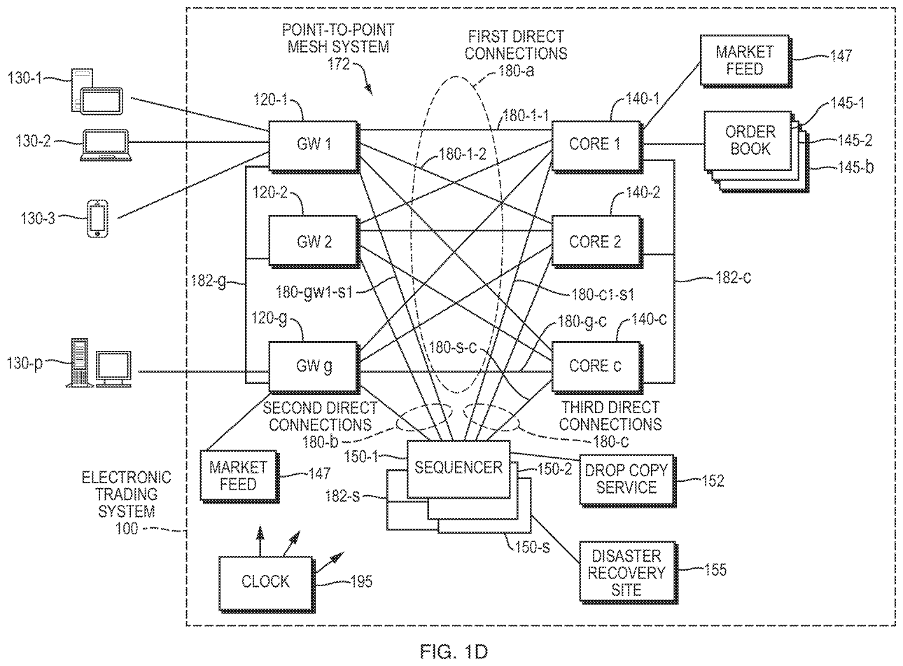

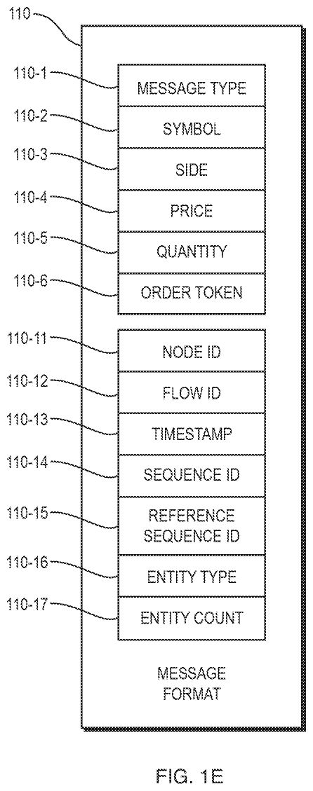

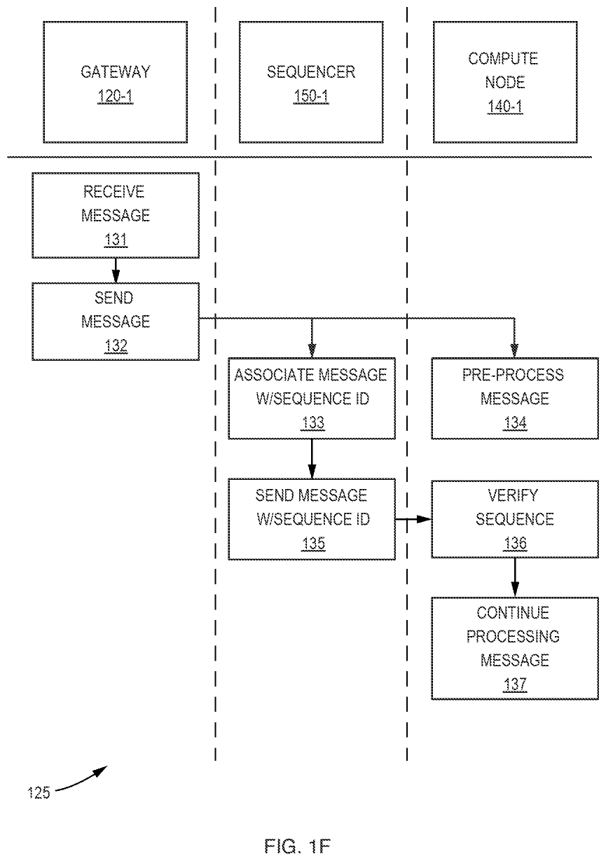

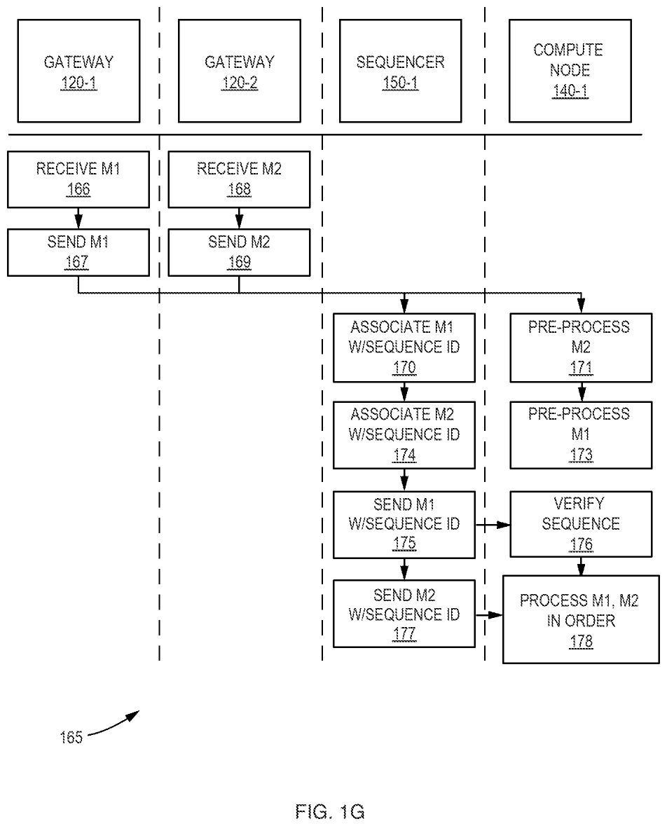

FIG. 1A is a block diagram of an example embodiment of a market 90 that includes an example embodiment of an electronic trading system 100 used for trading financial instruments (not shown). The electronic trading system 100 is primarily responsible for “matching” trade orders to one another and employs a point-to-point mesh system 102 for matching same. In one example, an offer to “buy” a financial instrument is matched by a matching engine of the point-to-point mesh system 102 to a corresponding counteroffer to “sell.” The matched offer and counteroffer must at least partially satisfy the desired price, with any residual unsatisfied quantity passed to another suitable counterorder. Matched trade orders are then paired and the trade is executed.

Any wholly unsatisfied or partially satisfied orders are maintained in a data structure referred to as an “order book” (not shown). The retained information regarding unmatched trade orders can be used by the matching engine to satisfy subsequent trade orders. An order book is typically maintained for each financial instrument and generally defines or otherwise represents the state of the market 90 for that particular product, that is, for that particular financial instrument. The order book may include, for example, the recent prices and quantities at which market participants have expressed a willingness to buy or sell.

The results of matching may also be made visible to market participants via streaming data services (not shown) referred to as market data feeds (not shown). A market data feed typically includes individual messages that carry the pricing for each traded financial instrument, and related information, such as volume and other statistics.

In the market 90, the market participants include two traders, namely a first trader 104a and second trader 104b. It should be understood that the market 90 is not limited to market participants that are traders and the market 90 is not limited to two traders. In the market 90, market participants, such as the first trader 104a and second trader 104b, may submit trade orders and receive confirmations, market data, and other information, electronically, via a communications network (not shown).

In the example embodiment of FIG. 1A, the first trader 104a has submitted a first trade order (not shown) to buy a financial instrument (not shown) via the first incoming message 3a that is transmitted to the electronic trading system 100 via a first participant device 130a. The electronic trading system 100 has employed the point-to-point mesh system 102 to match the first trade order with a second trade order (not shown) to sell the financial instrument. The second trade order to sell the financial instrument is submitted by the second trader 104b via the second incoming message 3b that is transmitted to the electronic trading system 100 via the second participant device 130b.

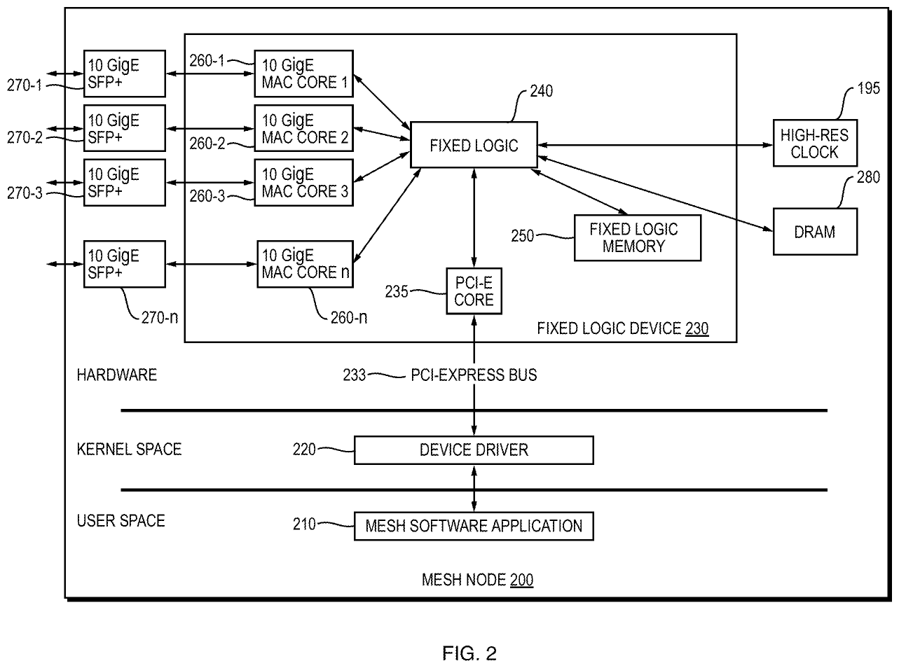

In the example embodiment, the electronic trading system 100 transmits a first outgoing message 5a and second outgoing message 5b to the first participant device 130a and second participant device 130b, respectively, to notify the first trader 104a and second trader 104b, respectively, that such respective trade orders have been executed successfully. The point-to-point mesh system 102 enables the electronic trading system 100 to perform high-speed, deterministic, electronic trading of financial instruments. An example embodiment of the point-to-point mesh system 102 is disclosed below with reference to FIGS. 1B-1 and 1B-2.

FIG. 1B-1 is a block diagram of an example embodiment of the electronic trading system 100 of FIG. 1A, disclosed above. In the particular embodiment, the electronic trading system 100 comprises a gateway 120-1 coupled to a core compute node 140-1 via an activation link 180-1-1 and an ordering (i.e., sequencing) path 117. The electronic trading system 100 further comprises a sequencer 150-1 electronically disposed within the ordering path 117. The gateway 120-1 is configured to transmit a message (not shown) to the core compute node 140-1 via the activation link 180-1-1 and the ordering path 117. The message may be the message 106 disclosed below with regard to FIG. 1B-2. The core compute node 140-1 is configured to receive the message and a sequence-marked version (not shown) of the message from the gateway 120-1 and sequencer 150-1, respectively. The sequence-marked version of the message may be the sequence-marked message 106′ of FIG. 1B-2, disclosed further below. The sequence-marked version (i.e., the sequence-marked message 106′) includes a sequence identifier (ID), such as may be included in a sequence ID field 110-14 of the sequence-marked message 106′ as disclosed further below with regard to FIG. 1E for non-limiting example. The sequence ID indicates a deterministic position of the sequence-marked version of the message among a plurality of sequence-marked versions of other messages, the other messages having been communicated via the activation link 180-1-1 and received by the sequencer 150-1 via the ordering path 117. The plurality of messages among which the sequence ID indicates a deterministic position also includes the other sequenced-marked versions of messages received by the core compute node 140-1 via the ordering path 117. The message (e.g., unsequenced message or unsequence-marked message) and sequence-marked version include common metadata (not shown). By correlating the message with its sequence-marked version via the common metadata, as disclosed further below, the sequence ID of the message is identified. The sequence ID further indicates a deterministic position of the message among all messages communicated throughout the electronic trading system 100 that pass through the sequencer 150-1 and are, thus, sequence-marked by the sequencer 150-1.

While elements of the electronic trading system 100 may timestamp messages communicated therein, it should be understood that the sequence ID determined by the sequencer 150-1 determines the position (order/priority) of the messages communicated in the electronic trading system 100. It is possible that multiple systems may timestamp messages with a same timestamp and, thus, order/priority for such messages would need to be resolved at a receiver of same. Such is not the case in the electronic trading system 100 as the sequencer 150-1 may be the sole determiner of order/priority of messages communicated throughout the electronic trading system 100.

The core compute node 140-1 may be configured to (i) commence a matching function activity for an electronic trade responsive to receipt of the message via the activation link 180-1-1, and (ii) responsive to receipt of the sequence-marked version via the ordering path 117, use the sequence identifier to prioritize completion of the matching function activity toward servicing the electronic trade.

The message and sequence-marked version may include common metadata. The core compute node 140-1 may be further configured to correlate the message with the sequence-marked version based on the common metadata responsive to receipt of the sequence-marked version via the ordering path 117.

In the example embodiment of FIG. 1B-1, the message is transmitted to the core compute node 140-1 via the activation link 180-1-1 in an activation link forward direction, that is, the act-link-fwd-dir 113a, and to the core compute node 140-1 via the ordering path 117 in an ordering path forward direction, that is the order-path-fwd-dir 115a. Further to completion of the matching function activity, the core compute node 140-1 may transmit a response (not shown) to the gateway 120-1 via the activation link 180-1-1 and the ordering path 117 in an activation link reverse direction (i.e., the act-link-rev-dir 113b) and an ordering path reverse direction (i.e., order-path-rev-dir 115b). The response transmitted to the gateway 120-1 via the activation link 180-1-1 and ordering path 117 may be the response 107 disclosed further below with regard to FIG. 1B-2.

The activation link 180-1-1 is a single direct connection while the ordering path 117 includes multiple direct connections. For example, the activation link 180-1-1, also referred to as the first direct connection 180-1-1, is a single direct connection while the ordering path 117 may include the second direct connection 180-gw1-s1 and third direct connection 180-c1-s1 disclosed further below with regard to FIG. 1B-2.

The gateway 120-1, sequencer 150-1, and core compute node 140-1 are arranged in a point-to-point mesh topology. The core compute node 140-1 may be configured to perform a matching function (i.e., an electronic trading matching function) toward servicing trade requests received from participant devices and introduced into the point-to-point mesh topology via the gateway 120-1. Such participant devices are disclosed further below with regard to FIG. 1B-2. The point-to-point mesh topology includes a first direct connection, second direct connection, and third direction connection, as disclosed above and disclosed further below with regard to FIG. 1B-2. The sequencer 150-1 may be configured to (i) determine a deterministic order (i.e., sequence) for messages communicated between the gateway 120-1 and core compute node 140-1 via the first direct connection and received by the sequencer 150-1 from the gateway 120-1 or core compute node 140-1 via the second or third direct connection, respectively. The sequencer 150-1 may be further configured to (ii) convey position of the messages within the deterministic order by transmitting sequence-marked versions of the messages to the gateway 120-1 and core compute node 140-1 via the second and third direct connections, respectively. The messages represent the trade requests or responses thereto, such as disclosed below with regard to FIG. 1B-2.

FIG. 1B-2 is another block diagram of an example embodiment of the electronic trading system 100 of FIG. 1A, disclosed above. The electronic trading system 100 comprises a gateway 120-1, a core compute node 140-1 configured to perform an electronic trading matching function, and a sequencer 150-1. The gateway 120-1 and core compute node 140-1 are coupled via a first direct connection 180-1-1. The gateway 120-1 and sequencer 150-1 are coupled via a second direct connection 180-gw1-s1. The sequencer 150-1 and core compute node 140-1 are coupled via a third direct connection 180-c1-s1. The first direct connection 180-1-1, second direct connection 180-gw1-s1, and third direct connection 180-c1-s1 have respective non-shared bandwidths.

In some figures of the disclosure, arrowheads are included on a direct connection (i.e., direct link), such as the arrowheads of the first direct connection 180-1-1, second direct connection 180-gw1-s1, and third direct connection 180-c1-s1 shown in FIG. 1B-2. Such arrowheads on a direct connection/link indicate that data may flow, bi-directionally, via the direct connection/link. While other figures of the disclosure may not have such arrowheads applied to a direct connection/link, such as FIG. 1B-1, disclosed above, and FIG. 1D, disclosed further below, it should be understood that data may flow bi-directionally along such connections/links and that such connections/links may be a single communication link or two links, in parallel, wherein each of the two links is uni-directional and data flows in opposite directions via the two links.

Continuing with reference to FIG. 1B-2, the gateway 120-1 is configured to transmit a message 106 (i.e., B), representing an electronic trade request with an offer to buy or sell a financial instrument, to the core compute node 140-1 via the first direct connection 180-1-1, the message 106 received, in turn, by the core compute node 140-1. The gateway 120-1 is further configured to transmit the message 106 (i.e., B) via the second direct connection 180-gw1-s1 to the sequencer 150-1 which is configured to, in turn, transmit a sequence-marked message 106′ (i.e., C) to the core compute node 140-1 via the third direct connection 180-c1-s1, such as disclosed further below with regard to FIG. 1D. The sequencer 150-1 is interposed between the gateway 120-1 and core compute node 140-1 via the second and third direct connections. The sequence-marked message 106′ transmitted by the sequencer 150-1 is a sequenced version of the message transmitted by the gateway 120-1. The sequence-marked message is received, in turn, by the core compute node 140-1. The core compute node 140-1 is configured to determine relative ordering of the sequence-marked message 106′ among sequence-marked versions of other messages (not shown) received by the core compute node 140-1 in the electronic trading system 100. The core compute node 140-1 is further configured to complete the electronic trading matching function for the electronic trade request in accordance with the relative ordering determined, causing the offer to be matched with a counteroffer for the financial instrument enabling an electronic trade of the financial instrument.

It should be understood that the electronic trading matching function may include more than matching trade orders, per se. For example, the electronic trading matching function may include transmission of an acknowledgement message, such as disclosed further below with regard to FIG. 1D. Further, the core compute node 140-1 may perform a portion of the electronic trading matching function prior to receipt of the sequence-marked message 106′ that enables the core compute node 140-1 to expedite same. For example, further to receipt of the message 106 (e.g., non-sequence-marked message), the core compute node 140-1 may commence the electronic trading matching function by, for non-limiting example, loading data relating to a symbol identified in the message 106, such as a symbol of the symbol field 110-2 disclosed further below with regard to FIG. 1E, into a fast memory for later access. The symbol may represent a traded financial security, such as a stock symbol or stock ticker. It should be understood, however, that the core compute node 140-1 may commence (trigger) the electronic trading matching function by performing any type of activity associated with content of the message 106.

The sequencer 150-1 may be further configured to produce the sequence-marked message 106′ by marking the message 106, or representation thereof, with a unique sequence identifier (not shown). The unique sequence identifier may have a value corresponding to an arrival time of the message 106 at the sequencer 150-1 and may indicate a relative sequence position of the message 106 among a plurality of messages (not shown) received at the sequencer 150-1.

While the core compute node 140-1 may commence the electronic trading function upon receipt of the unsequenced message 106, as discussed above, thereby starting the processing of the unsequenced message 106, the core compute node 140-1 may not complete the processing and/or commit the results of the processing of message 106 until the core compute node 140-1 receives the sequence-marked message 106′. Without a deterministic ordering for processing a message, as specified via the sequence identifier in the sequence-marked message 106′, for example, the processing of messages by the compute node 140-1 could be unpredictable. As a non-limiting example of possible unpredictable results, there could be multiple outstanding unsequenced messages, each of which represents a potential match for the contra side in the exchange of a financial security. It is useful for there to be a deterministic way of arbitrating among the multiple potential matches because, perhaps, only a subset among the potential matches may be able to be filled against a given trade order on the contra side.

According to some embodiments, after having received both the unsequenced message 106 and the sequence-marked message 106′, the compute node 140-1 may correlate the unsequenced message 106 with the sequence-marked message 106′ via identifying information in both versions of the message, as discussed below in connection with FIG. 1E. Once the compute node 140-1 has received the sequence-marked message 106′, the compute node 140-1 may then determine the proper sequence in which message 106/106′ should be processed relative to the other messages throughout electronic trading system 100, and may then complete the processing of message 106/106′, including sending out an appropriate response message, possibly referencing the sequence identifier assigned by the sequencer to the sequence-marked message 106′. Returning to the non-limiting example of multiple messages representing potential matches for the contra side in the exchange of a financial security, once the sequence-marked versions of the messages representing potential matches are received by the compute node 140-1, the compute node 140-1 may determine precisely the sequence in which the possible match(es) are to occur and complete the electronic trading matching function.

According to an example embodiment, besides transmitting the sequence-marked message 106′ to compute node 140-1 via the third direct connection 180-c1-s1, the sequencer 150-1 may further transmit the sequence-marked message 106′ (i.e., C) via the second direct connection 180-gw1-s1 to the gateway 120-1. Providing the sequence-marked message 106′ (i.e., C) to the sender of the message 106 enables the sender, that is, the gateway 120-1, to correlate the sequence number assigned to the message, that is, the message 106, with other identifying information in the message (as discussed below in connection with FIG. 1E) so that the sender can easily deal with subsequent messages that reference that sequence number, as disclosed further below with regard to FIG. 1D.

The gateway 120-1, core compute node 140-1, sequencer 150-1, first direct connection 180-1-1, second direct connection 180-gw1-s1, and third direct connection 180-c1-s1 form the point-to-point mesh system 102. According to an example embodiment, in the point-to-point mesh system 102, the first direct connection 180-1-1, second direct connection 180-gw1-s1, and third direct connection 180-c1-s1, or a subset thereof, may be protected by at least one respective redundant direct connection (not shown). In an event such direct connection fails, a respective redundant direct connection may be employed instead. As such, the electronic trading system 100 may further comprise at least one respective redundant direct connection for the first, second, and third direction connections, or subset thereof.

According to an example embodiment, the electronic trading system 100 may further comprise a clock and the gateway 120-1, core compute node 140-1, and sequencer 150-1, may be synchronized based on the clock, such as the clock 195 of FIG. 1D, disclosed further below.

The message 106 may be referred to as a “gateway” message because it comes from a gateway, namely the gateway 120-1. The message 106 may also be referred to as a “compute-node-destined” message as it is destined for a compute node, namely, the core compute node 140-1 in the example embodiment. The message 106 is a gateway message transmitted by the gateway 120-1 in response to receipt of an incoming message 103 (i.e., A) received by the gateway 120-1 from a participant device (not shown). The sequence-marked message 106′ may be a first sequence-marked message. The core compute node 140-1 may be further configured to transmit a core compute node message, that is, the response 107 (i.e., D), via the first direct connection 180-1-1 to the gateway 120-1 in response to receiving the message 106, that is, the gateway message, and to transmit the core compute node message (i.e., response 107) via the third direct connection 180-c1-s1 to the sequencer 150-1 which is further configured to, in turn, transmit a second sequence-marked message, that is, the sequence-marked response 107′ (i.e., E), via the second direct connection 180-gw1-s1 to the gateway 120-1. The second sequence-marked message is a sequenced version of the core compute node message. The gateway 120-1 may be further configured to determine relative ordering of the second sequence-marked message (i.e., sequence-marked response 107′) and sequence-marked versions of other messages sent from the core compute node 140-1 to the gateway 120-1. The gateway 120-1 may be further configured to transmit an outgoing message 105 (i.e., F) to the participant device in accordance with the relative ordering determined. It should be understood that the message 106 and response 107 relate to trading activity.

The sequencer 150-1 may further transmit the second sequence-marked message, that is, the sequence-marked response 107′ (i.e., E), via the third direct connection 180-c1-s1 to the core compute node 140-1. Providing the sequence-marked response 107′ (i.e., E) to the sender of the response 107 enables the sender, that is, the core compute node 140-1, to correlate the sequence number assigned to the message, that is, the response 107, to other identifying information in the message (as discussed below in connection with FIG. 1E), so that the sender can easily deal with subsequent messages that reference that sequence number, as disclosed further below with regard to FIG. 1D.

Similar to the discussion above in connection with messages 106 and 106′ received by the compute node 140-1, upon receipt of the unsequenced response message 107, the gateway 120-1 may activate processing of such response message, even before the gateway 120-1 receives the sequence-marked response 107′. As non-limiting examples, activating (commencing) the processing could include updating the state of an open trade order database on the gateway 120-1 and/or building up an outgoing message 105 ready to be sent to the participant device. In some embodiments, the gateway 120-1, however, may not complete the processing of the sequence-marked response message 107, such processing including transmitting the outgoing message 105 to the participant device, until the gateway 120-1 has received the sequence-marked response message 107′, which contains a sequence identifier specifying a deterministic position of the response message 107 in a sequence of messages including the other messages in electronic trading system 100. In some embodiments, after having received both the unsequenced message 107 and the sequence-marked response message 107′, the gateway 120-1 may correlate the unsequenced response message 107 with the sequence-marked response message 107′ via identifying information in both versions of the message, as discussed below in connection with FIG. 1E. The deterministic position of the response message 107/107′ thereby being determined upon receipt of the sequence-marked response message 107′. In some embodiments, the processing of the response message may then be completed, such processing including committing the outgoing message 105 to be transmitted to the participant device.

The electronic trading system 100 may further comprise an order book (not shown) accessible by the core compute node 140-1. The core compute node 140-1 may be further configured to match trade orders related to a financial instrument (not shown) based on the electronic trading matching function performed. For example, the core compute node 140-1 may be further configured to match trade orders related to the financial instrument using the electronic trading matching function. The core compute node 140-1 may be further configured to maintain a residual position (not shown) of the financial instrument on the order book. An unmatched amount of the financial instrument may result from performing the electronic trading matching function. The residual position may include the unmatched amount of the financial instrument. It should be understood that the residual position can convey more information than quantity. For example, position can be long and short (side). According to an example embodiment, the residual position conveys both price and quantity.

The gateway 120-1 may be further configured to serve at least one participant device (not shown) and transmit the message 106 to the sequencer 150-1 and core compute node 140-1 in response to receipt of the incoming message 103 at the gateway 120-1. The incoming message 103 is sourced by the at least one participant device. The sequencer 150-1 may be further configured to produce the sequence-marked message by marking the message with a unique sequence identifier or by creating a representation of the message received, marking the representation with the unique sequence identifier, and transmitting the representation marked. The representation marked may be the sequence-marked message.

According to an example embodiment, the gateway 120-1 may be a given gateway among a plurality of gateways, such as the plurality of gateways of FIGS. 1C, 1D, 3, and 4, disclosed further below. Further, the core compute node 140-1 may be a given core compute node among a plurality of core compute nodes, such as the plurality of core compute nodes of FIGS. 1C, 1D, 3, and 4, disclosed further below.

FIG. 1C is a block diagram of an example embodiment of a point-to-point mesh system 122. The point-to-point mesh system 122 includes a plurality of gateways 120, a plurality of core compute nodes 140, and the sequencer 150-1. Each gateway 120-1, 120-2 . . . 120-g of the plurality of gateways 120 is coupled to each core compute node 140-1, 140-2 . . . 140-c of the plurality of core compute nodes 140 via respective first direct connections, namely the first direct connections 180-a. The sequencer 150-1 is coupled to each gateway of the plurality of gateways via respective second direct connections, namely the second direct connections 180-b, and coupled to each core compute node of the plurality of core compute nodes via respective third direct connections, namely the third direct connections 180-c. The plurality of gateways, plurality of core compute nodes, sequencer 150-1, and respective direct connections form at least a portion of a point-to-point mesh system 122.

Within the point-to-point mesh system 122, each gateway of the plurality of gateways 120 is configured to transmit a respective compute-node-destined message transmitted therefrom to all compute nodes of the plurality of core compute nodes 140 and to the sequencer 150-1. Within the point-to-point mesh system 122, each core compute node of the plurality of core compute nodes 140 is configured to transmit a respective gateway-destined message transmitted therefrom to all gateways of the plurality of gateways 120 and to the sequencer 150-1. Within the point-to-point mesh system 122, the sequencer 150-1 is further configured to transmit, to the plurality of gateways 120 and plurality of core compute nodes 140, a respective sequence-marked message in response to receipt of the respective compute-node-destined message or the respective gateway-destined message.

The respective compute-node-destined message transmitted by a given gateway of the plurality of gateways 120 is a same message received by the plurality of core compute nodes 140. At least two compute nodes 140 among the plurality of core compute nodes 140 may be configured to generate response messages in response to receipt of the same message. The response messages may be received at the given gateway from among the plurality of core compute nodes. The given gateway may be further configured to take action based on a given response message of the response messages generated in response to receipt of the same message. The given response message may be first to arrive at the given gateway relative to other response messages generated in response to receipt of the same message. The given gateway may be further configured to ignore the other response messages that arrive after the given response message. Such response messages may be referred to as functionally equivalent messages. Functionally equivalent messages represent a same message to cause recipients of such functionally equivalent messages to perform a same function (e.g., activity or activities). While the functionally equivalent messages may represent the same message, and in some embodiments may actually be identical, in other embodiments, functionally equivalent messages may not necessarily be identical as they may, possibly, include different metadata, such as different timestamps, different source identifiers, etc., for non-limiting example. As a point of clarification, the term “functionally equivalent messages” does not refer to a non-sequence marked message in relation to its sequence marked message counterpart. Rather, functionally equivalent messages generally refer to a plurality of non-sequenced marked messages that represent a same non-sequence marked message, although in some embodiments, there may also exist a plurality of sequence marked messages that represent a same sequence marked message, such that we may refer to functionally equivalent non-sequence marked messages or functionally equivalent sequence marked messages. The description related to FIG. 1E below describes at least one example of how a recipient node may determine that two or more such response messages are functionally equivalent and represent the same message.

A plurality of functionally equivalent messages (not shown) may be received from among the plurality of core compute nodes 140, plurality of sequencers 150, or a combination thereof, at the given gateway and the given gateway may be further configured to take action based on a given functionally equivalent message of the plurality of functionally equivalent messages, the given functionally equivalent message being first to arrive at the given gateway. The given gateway may be further configured to ignore other functionally equivalent messages of the plurality of functionally equivalent messages that arrive after the given functionally equivalent message. Such messages may be understood to be “functionally” equivalent because as multiple core compute nodes each independently generate a response message for the same message received at the multiple core compute nodes, each of the respective responses functionally leads to the same result without being strictly identical. For example, such response messages may at least have different originating core identifiers included therein to uniquely identify the particular core compute node that is sending the response.

According to an example embodiment, at least two such “functionally equivalent messages” may arrive at a given core compute node, such as the core compute node 140-1, from a gateway(s)/sequencer(s), and the given core compute node may be configured such that it only processes the message that arrives first among such functionally equivalent messages. As such, a plurality of functionally equivalent messages may be received from among the plurality of gateways, plurality of sequencers, or combination thereof, at the given compute node. The given compute node may be further configured to take action based on a given functionally equivalent message of the plurality of functionally equivalent messages, the given functionally equivalent message being first to arrive at the given compute node. The given compute node may be further configured to ignore other functionally equivalent messages of the plurality of functionally equivalent messages that arrive after the given functionally equivalent message.

As such, a plurality of compute-node destined messages representing a same message may be received from among the plurality of gateways 120, at a given compute node, such as the compute node 140-1. Such may be the case when the electronic trading system 100 is configured for high availability (HA). For example, redundant flows from participant devices may be received among the plurality of gateways and, as such, a plurality of compute-node destined messages representing a same message may be transmitted by such gateways to the compute nodes 120. According to an example embodiment, a given core compute node may be configured to take action based on a given compute-node-destined message of the plurality of compute-node destined messages, the given compute-node-destined message being first to arrive at the given compute node relative to other compute-node-destined messages of the plurality of compute-node-messages representing the same message. The given core compute node may be further configured to ignore the other compute-node-destined messages that arrive after the given compute-node-destined message. Such a plurality of compute-node-destined messages representing a same message may be referred to as functionally equivalent messages. The description related to FIG. 1E below describes at least one example of how a recipient node may determine that two or more such compute-node-destined messages are functionally equivalent and represent the same message.

The electronic trading system 100 may be an active electronic trading system, in which at least one sequencer of the plurality of sequencers may be communicatively coupled to a disaster recovery site that includes a standby electronic trading system, such as the disaster recovery site 155 of FIG. 1D, disclosed below.

FIG. 1D is a block diagram of another example embodiment of an electronic trading system. FIG. 1D illustrates an example electronic trading system 100 that includes a number of gateways 120-1, 120-2, . . . , 120-g (collectively referred to as the gateways 120), a set of core compute nodes 140-1, 140-2, . . . , 140-c (collectively, the core compute nodes 140 or compute nodes 140), and one or more sequencers 150-1, 150-2, . . . , 150-s (collectively, the sequencers 150). In some embodiments, the gateways 120, core compute nodes 140, and sequencers 150 are, thus, considered to be nodes in the electronic trading system 100. As will be described in more detail below, in one embodiment, the gateways 120, compute nodes 140 and sequencers 150 are directly connected to one another, preferably via low latency, dedicated connections 180.

The term “peer” in relation to the discussion of the electronic trading system 100 refers to another device that generally serves the same function (e.g., “gateway” vs. “core compute node” vs. “sequencer”) in the electronic trading system 100. For example, the gateways 120-2, . . . , 120-g are the peers for gateway 120-1, the core compute nodes 140-2, . . . , 140-c are the peers for the core compute node 140-1, and the sequencers 150-2, . . . , 150-s are the peers for the sequencer 150-1.

The terms “active” and “standby,” in relation to the discussion of the system 100, may refer to a high availability (HA) role/state/mode of a system/component. In general, a standby system/component is a redundant (backup) system/component that is powered on and ready to take over function(s) performed by an active system/component. Such switchover/failover, that is, a transition from the standby role/state/mode to the active role/state/mode, may be performed automatically in response to failure of the currently active system/component for non-limiting example.

The electronic trading system 100 processes trade orders from and provides related information to one or more participant computing devices 130-1, 130-2, . . . , 130-p (collectively, the participant devices 130). The participant devices 130 interact with the electronic trading system 100, and may be one or more personal computers, tablets, smartphones, servers, or other data processing devices configured to display and receive trade order information. The participant devices 130 may be operated by a human via a graphical user interface (GUI), or they may be operated via high-speed automated trading methods running on a physical or virtual data processing platform. Each participant device 130 may exchange messages with (that is, send messages to and receive messages from) the electronic trading system 100 via connections established with a gateway 120. While FIG. 1D illustrates each participant device 130 as being connected to electronic trading system 100 via a single connection to a gateway 120, it should be understood that a participant device 130 may be connected to the electronic trading system 100 over multiple connections to one or more gateway devices 120.

Note that, while each gateway 120-1 may serve a single participant device 130, it typically serves multiple participant devices 130.

The compute nodes 140-1, 140-2, . . . , 140-c (also referred to herein as matching engines 140 or compute engines 140) provide the matching functions described above and may also generate outgoing messages to be delivered to one or more participant devices 130. Each compute node 140 is a high-performance data processor and typically maintains one or more data structures to search and maintain one or more order books 145-1, 145-2, . . . , 145-b. An order book 145-1 may be maintained, for example, for each instrument for which the core compute node 140-1 is responsible. One or more of the compute nodes 140 and/or one or more of the gateways 120 may also provide market data feeds 147. Market data feeds 147 may be broadcast (for example, multicast), to subscribers, which may be participant devices 130 or any other suitable computing devices.

Some outgoing messages generated by the core compute nodes 140 may be synchronous, that is, generated directly by a core compute node 140 in response to one or more incoming messages received from one or more participant devices 130, such as an outgoing “acknowledgement message” or “execution message” in response to a corresponding incoming “new order” message. In some embodiments, however, at least some outgoing messages may be asynchronous, initiated by the trading system 100, for example, certain “unsolicited” cancel messages and “trade break” or “trade bust” messages.

Distributed computing environments, such as the electronic trading system 100, can be configured with multiple matching engines operating in parallel on multiple compute nodes 140.

The sequencers 150 ensure that the proper sequence of any order-dependent operations is maintained. To ensure that operations on incoming messages are not performed out of order, incoming messages received at one or more gateways 120, for example, a new trade order message from one of participant devices 130, typically may then pass through at least one sequencer 150 (e.g., a single currently active sequencer, and possibly one or more standby sequencers) in which they are marked with a sequence identifier (by the single currently active sequencer, if multiple sequencers are present). That identifier may be a unique, monotonically increasing value which is used in the course of subsequent processing throughout the distributed system 100 (e.g., electronic trading system 100), to determine the relative ordering among messages and to uniquely identify messages throughout electronic trading system 100. In some embodiments, the sequence identifier may be indicative of the order (i.e., sequence) in which a message arrived at the sequencer. For example, the sequence identifier may be a value that is monotonically incremented or decremented according to a fixed interval by the sequencer for each arriving message; for example, the sequence identifier may be incremented by one for each arriving message. It should be understood, however, that, while unique, the sequence identifier is not limited to a monotonically increasing or decreasing value. In some embodiments, the original, unmarked, messages and the sequence-marked messages may be essentially identical, except for the sequence identifier value included in the marked versions of the messages. Once sequenced, the marked incoming messages, that is, the sequence-marked messages, are typically then forwarded by sequencer(s) 150 to other downstream compute nodes 140 to perform potentially order-dependent processing on the messages. Thus, besides uniquely identifying a message throughout electronic trading system 100, the sequence identifier assigned by the sequencer 150 may also determine a relative ordering of each marked message among other marked messages in the electronic trading system 100.

As such, in contrast to other purposes for which a sequence identifier may be employed, the unique sequence identifier disclosed herein may be used for ensuring deterministic order (i.e., sequence) for electronic-trade message processing. The unique sequence identifier represents a unique, deterministic ordering (i.e., sequence) directive for processing of a given electronic trade message relative to other trade messages within an electronic trading system. According to an example embodiment, the sequence identifier may be populated in a sequence ID field 110-14 of a message, as disclosed further below with regard to FIG. 1E for non-limiting example.

In some embodiments, messages may also flow in the other direction, that is, from a core compute node 140 to one or more of the participant devices 130, passing through one or more of the gateways 120. Such outgoing messages generated by a core compute node 140 may also be order-dependent (i.e., sequence-order dependent), and accordingly may also typically first pass through a sequencer 150 to be marked with a sequence identifier. The sequencer 150 may then forward the marked response message to the gateways 120 in order to pass on to participant devices 130 in a properly deterministic order.

The use of a sequencer 150 to generate unique sequence numbers and mark messages or representations thereof with same, that is, to generate sequence-marked messages, ensures the correct ordering of operations is maintained throughout the distributed system, that is, the electronic trading system 100, regardless of which compute node or set of compute nodes 140 processes the messages. This approach provides “state determinism,” for example, an overall state of the system is deterministic and reproduceable (possibly somewhere else, such as at a disaster recovery site), to provide fault-tolerance, high availability and disaster recoverability.

It may also be important for a generating node (i.e., a node introducing a new message into the electronic trading system 100, for example by generating a new message and/or by forwarding a message received from a participant device 130) and its peer nodes to receive the sequence number assigned to that message. Receiving the sequence number for a message it generated may be useful to the generating node and its peer nodes not only for processing messages in order, according to their sequence numbers, but also to correlate the message generated by the node with the message's sequence identifier that is used throughout the rest of the electronic trading system 100. Such a correlation between an unmarked version of a message as introduced by a generating node into the electronic trading system and the sequence marked version of the same message outputted by the sequencer may be made via identifying information in both versions of the message, as discussed further below in connection with FIG. 1E. A subsequent message generated within the electronic trading system 100, while also being assigned its own sequence number, may yet reference one or more sequence numbers of related preceding messages. Accordingly, a node may need to quickly reference (by sequence number) a message the node had itself previously generated, because, for example, the sequence number of the message the node had generated was referenced in a subsequent message.

In some embodiments, the generating node may first send a message to the sequencer 150 and wait to receive the sequence number for the message from the sequencer before the generating node forwards the message to other nodes in electronic trading system 100.

In alternate example embodiments, to avoid at least one hop, which could add undesirable increased latency within electronic trading system 100, after receiving the un-sequenced message from the generating node, the sequencer 150 may not only send a sequenced version of the message (i.e., a sequence-marked message) to destination nodes, but may also send substantially simultaneously a sequenced version of the message back to the sending node and its peers. For example, after assigning a sequence number to an incoming message sent from the gateway 120-1 to core compute nodes 140, the sequencer 150 may not only forward the sequenced version of the message to the core compute nodes 140, but may also send a sequenced version of that message back to the gateway 120-1 and the other gateways 120. Accordingly, if any subsequent message generated in a core compute node 140 references that sequence number, any gateway 120 may easily identify the associated message originally generated by gateway 120-1 by its sequence number.

Similarly, in some further embodiments, a sequenced version of an outgoing message generated by and sent from a core compute node 140 to gateways 120, and sequenced by sequencer 150, may be forwarded by sequencer 150 both to gateways 120 and back to core compute nodes 140.

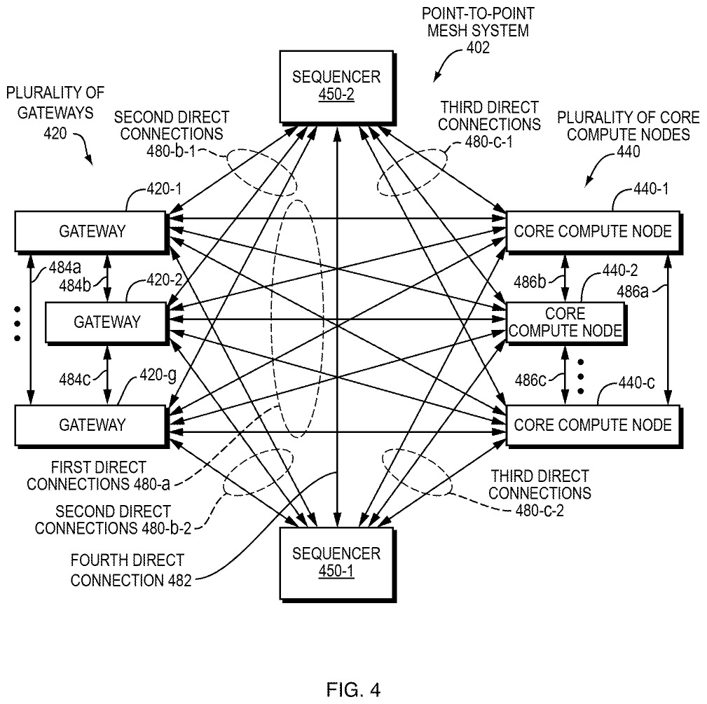

Some embodiments may include multiple sequencers 150 for high availability, for example, to ensure that another sequencer is available if the first sequencer fails, such as disclosed further below with regard to FIG. 4. For embodiments with multiple sequencers 150 (e.g., a currently active sequencer 150-1, and one or more standby sequencers 150-2, . . . , 150-s), the currently active sequencer 150-1 may maintain a system state log (not shown) of all the messages that passed through sequencer 150-1, as well as the messages' associated sequence numbers. This system state log may be continuously or periodically transmitted to the standby sequencers to provide them with requisite system state to allow them to take over as an active sequencer, if necessary. Alternatively, the system state log may be stored in a data store that is accessible to the multiple sequencers 150.

The system state log may also be continually or periodically replicated to one or more sequencers in a standby replica electronic trading system (not shown in detail) at a disaster recovery site 155, thereby allowing electronic trading to continue with the exact same state at the disaster recovery site 155, should the primary site of the electronic trading system 100 suffer catastrophic failure.

According to an example embodiment, a currently active sequencer of a plurality of sequencers may store the system state log in a data store (not shown). The data store may be accessible to the plurality of sequencers via a shared sequencer network, such as the sequencer-wide shared network 182-s disclosed further below with regard to FIG. 1D. In an event a given sequencer of the plurality of sequencers transitions its role (state) from standby to active, such sequencer may retrieve the system state log from the data store to synchronize state with that of the former active sequencer.

In some embodiments, the system state log may also be provided to a drop copy service 152, which may be implemented by one or more of the sequencers, and/or by one or more other nodes in the electronic trading system 100. The drop copy service 152 may provide a record of daily trading activity through the electronic trading system 100 that may be delivered to regulatory authorities and/or clients, who may, for example be connected via participant devices 130. In alternate embodiments, the drop copy service 152 may be implemented on one or more of the gateways 120. Furthermore, in addition to or instead of referencing the system state log, the drop copy service 152 may provide the record of trading activity based on the contents of incoming and outgoing messages sent throughout the electronic trading system 100. For example, in some embodiments, a gateway 120 implementing the drop copy service 152 may receive from the sequencer 150 (and/or from core compute nodes 140 and other gateways 120) all messages exchanged throughout the electronic trading system 100. A participant device 130 configured to receive the record of daily trading activity from the drop copy service 152 may not necessarily also be sending trade orders to and utilizing a matching function of the electronic trading system 100.

Messages exchanged between participant devices 130 and gateways 120 may be according to any suitable protocol that may be used for financial trading (referred to for convenience as, “financial trading protocol”). For example, the messages may be exchanged according to custom protocols or established standard protocols, including both binary protocols (such as Nasdaq OUCH and NYSE UTP), and text-based protocols (such as NYSE FIX CCG). In some embodiments, the electronic trading system 100 may support exchanging messages simultaneously according to multiple financial trading protocols, including multiple protocols simultaneously on the same gateway 120. For example, the participant devices 130-1, 130-2, and 130-3 may simultaneously have established trading connections and may be exchanging messages with the gateway 120-1 according to Nasdaq Ouch, NYSE UTP, and NYSE FIX CCG, respectively.

Furthermore, in some embodiments, the gateways 120 may translate messages according to a financial trading protocol received from a participant device 130 into a normalized (e.g., standardized) message format used for exchanging messages among nodes within the electronic trading system 100. The normalized trading format may be an existing protocol or may generally be of a different size and data format than that of any financial trading protocol used to exchange messages with participant devices 130. For example, the normalized trading format, when compared to a financial trading protocol of the original incoming message received at the gateway 120 from a participant device 130, may include in some cases one or more additional fields or parameters, may omit one or more fields or parameters, and/or each field or parameter of a message in the normalized format may be of a different data type or size than the corresponding message received at gateway 120 from the participant device 130. Similarly, in the other direction, the gateways 120 may translate outgoing messages generated in the normalized format by the electronic trading system 100 into messages in the format of one or more financial trading protocols used by the participant devices 130 to communicate with the gateways 120.

FIG. 1E is a table of an example embodiment of fields of a message format 110 for trading messages, such as trading messages exchanged among nodes in the electronic trading system 100 disclosed above. In the example embodiment of FIG. 1E, the message format 110 is a normalized message format, intended to be used for an internal (that is, within the electronic trading system 100) representation of trading messages when they are exchanged among nodes within electronic trading system 100. In this example embodiment, gateways 120 exchange messages between the participants 130 and electronic trading system 100, and translate such messages between format(s) specified by one or more financial trading protocols used by the participants 130 and the normalized trading format used among nodes in the electronic trading system 100. It should be understood that the fields 110-1 through 110-17 are for non-limiting example and that the message format 110 may include more, fewer, or different fields, and that the order of such fields is not limited to as shown in FIG. 1E.

While the fields in the message format 110 are shown in this example in a single message format, they may be distributed across multiple message formats, or encapsulated in layered protocols. For example, in other embodiments, a subset of fields in the message format 110 may be included as part of a header, trailer, or extension field(s) in a layered protocol that encapsulates other fields of the message format 100 in a message payload. According to some example embodiments, the message format 100 may define one or more fields of data encapsulated in a payload (data) section of another message format, including without limitation a respective payload section of an IP datagram, a UDP datagram, a TCP packet, or of a message data frame format, such as an Ethernet data frame format or other data frame format, including InfiniBand, Universal Serial Bus (USB), PCI Express (PCI-e), and High-Definition Multimedia Interface (HDMI), for non-limiting example.

The message format 110 includes fields 110-1 . . . 110-6 which correspond to information that may be included in messages sent or received according to a financial trading protocol for communication with one or more participant devices 130. For non-limiting example, the message type field 110-1 indicates a trading message type. Some trading message types (such as, message types “new order,” “replace order,” or “cancel order”) correspond to messages received from participant devices 130, while other message types (such as, “new order acknowledgement,” “replace order acknowledgement,” “cancel order acknowledgement,” “fill,” “execution report,” “unsolicited cancel,” “trade bust,” or various reject messages) correspond to messages that are generated by the electronic system 100 and are included in trading messages sent to the participant devices 130.

The message format 110 also includes a symbol field 110-2, which includes an identifier for a traded financial security, such as a stock symbol or stock ticker. For example, “IBM” is the stock symbol for “International Business Machines Corporation.” The side field 110-3 in the message format 110 may be used to indicate the “side” of the trading message, such as whether the trading message is a “buy,” “sell,” or a “sell short.” Similarly, the price field 110-4 may be used to indicate a desired price to buy or sell the security, and the quantity field 110-5 may be used to indicate a desired quantity of the security (e.g., number of shares). The message format 110 may also include the order token field 110-6, which may be populated with an “order token” or “client order ID” initially provided by a participant device 130 to uniquely identify a new order in the context of a particular trading session (i.e., “connection” or “flow”) established between the participant device 130 and the electronic trading system via a gateway 120.

It should be understood that fields 110-1 . . . 110-6 are representative fields that are usually included for most message types according to most financial trading protocols, but that the message format 110 may well include additional or alternate fields, especially for supporting particular message types or particular financial trading protocols. For example, according to many financial trading protocols, “replace order” and “cancel order” message types require the participant 130 to supply an additional order token to represent the replaced or canceled order, to distinguish it from the original order. Similarly, a “replace order” and a “cancel order” typically may also include a replaced/canceled quantity field, and a “replace order” may include a replace price field. These additional replace/cancel order token fields, replace price fields, and replaced/canceled quantity fields, may also be included in corresponding acknowledgement messages sent by electronic trading system 100.

Additionally, the message format 110 includes fields 110-11 . . . 110-17 that may be used internally within electronic trading system 100, and do not necessarily correspond to fields in messages exchanged with participant devices 130. For example, a node identifier field 110-11 may uniquely identify each node in electronic trading system 100. In some embodiments, a generating node may include its node identifier in messages it introduces into the electronic trading system 100. For example, each gateway 120 may include its node identifier in messages it forwards from participant devices 130 to compute nodes 140 and/or sequencers 150. Similarly, each compute node 140 may include its node identifier in messages it generates (for example, acknowledgements, executions, or types of asynchronous messages intended ultimately to be forwarded to one or more participant devices 130) to be sent to other nodes in the electronic trading system 100. Thus, via the node identifier field 110-11 in the message, each message introduced into the electronic trading system 100 may be associated with the message's generating node.

The message format 110 may also include a flow identifier field 110-12. In some embodiments, each trading session (i.e., “connection” or “flow”) established between a participant device 130 and a gateway 120 may be identified with a flow identifier that is intended to be unique throughout the electronic trading system 100. As discussed in connection with FIG. 1D above, a participant device 130 may be connected to the electronic trading system 100 over one or more flows, and via one or more of the gateways 120. In such embodiments, the version of the messages according to the normalized message format 110 (used among nodes in the electronic trading system 100) of all messages exchanged between a participant device 130 and the electronic trading system 100 over a particular flow would include a unique identifier for that flow in the flow identifier field 110-12. In some embodiments, the flow identifier field 110-12 is populated by a message's generating node. For example, a gateway 120 may populate the flow identifier field 110-12 with the identifier of the flow associated with a message it receives from a participant 130 that the gateway 120 introduces into electronic trading system 100. Similarly, a core compute node 140 may populate the flow identifier field 110-12 with the flow identifier associated with messages it generates (i.e., response messages, such as acknowledgement messages or fills, or other outgoing messages including asynchronous messages).

In some embodiments, the flow identifier field 110-12 contains a value that uniquely identifies a logical flow, which actually could be implemented for purposes of high availability as multiple redundant trading session connections, possibly over multiple gateways. That is, in some embodiments, the same flow ID may be assigned to two or more redundant flows between participant device(s) 130 and gateway(s) 120. In such embodiments, the redundant flows may be either in an active/standby configuration or an active/active configuration. In an active/active configuration, functionally equivalent messages may be exchanged between participant device(s) 130 and gateway(s) 120 simultaneously over multiple redundant flows in parallel. That is, a trading client may send in parallel over the multiple redundant flows functionally equivalent messages simultaneously to the electronic trading system 100, and receive in parallel over the multiple redundant flows multiple functionally equivalent responses from the electronic trading system 100, although the electronic trading system 100 may only take action on a single such functionally equivalent message. In an active/standby configuration, a single flow at a time among the multiple redundant flows may be designated as an active flow, whereas the other flow(s) among the multiple redundant flows may be designated standby flow(s), and the trading messages would only actually be exchanged over the currently active flow. Regardless of whether the redundant flows are configured in an active/active or active/standby configuration, messages exchanged over any of the redundant flows may be identified with the same flow identifier stored by the messages' generating nodes in the flow identifier field 110-12 of the normalized message format 110.

As discussed above, in some embodiments, messages exchanged among nodes in the electronic system 100 are sent to the sequencer 150 to be marked with a sequence identifier. Accordingly, the message format 110 includes sequence identifier field 110-14. In some embodiments, an “unmarked message” may be sent with a sequence identifier field 110-14 having an empty, blank (e.g., zero) value. In other embodiments, the sequence identifier field 110-14 of an unmarked message may be set to a particular predetermined value that the sequencer would never assign to a message, or to an otherwise invalid, value. Still other embodiments may specify that a message is unmarked via an indicator in another field (not shown) of the message, such as a Boolean value or a flag value indicating whether a message has been sequenced. Upon receiving an unmarked message, the sequencer 150 may then populate the sequence identifier field 110-14 of the unmarked message with a valid sequence identifier value, thereby producing a “sequence marked message.” The valid sequence identifier value in sequence identifier field 110-4 of the sequence marked message uniquely identifies the message and also specifies a deterministic position of the marked message in a relative ordering of the marked message among other marked messages throughout electronic trading system 100. In this example, a “sequence marked message” sent by the sequencer 150 may then be identical to a corresponding unmarked message received by the sequencer except that the sequence marked message's sequence identifier field 110-14 contains a valid sequence identifier value.

The message format 110 may, in some embodiments, also include the reference sequence identifier field 110-15. A generating node may populate the reference sequence identifier field 110-15 of a new message it generates with the value of a sequence number of a prior message related to the message being generated. The value in the reference sequence identifier field 110-15 allows nodes in electronic trading system 100 to correlate a message with a prior associated message.

The prior associated message referenced in the reference sequence identifier field 110-15 may be a prior message in the same “order chain” (i.e., “trade order chain”). According to most financial trading protocols, messages may be logically grouped into an “order chain,” a set of messages over a single flow that reference or “descend from” a common message. An order chain typically starts with a “new order message” sent by a participant device 130. The next message in the order chain is typically a response by the electronic trading system (e.g., either a “new order acknowledgement” message when the message is accepted by the trading system, or a “new order reject” message, when the message is instead rejected by the trading system, perhaps for having an invalid format or invalid parameters, such as an invalid price for non-limiting example). An order chain may also include “cancel order” message sent by participant device 130, canceling at least a portion of the quantity of a prior acknowledged (but still open, that is contains at least some quantity that is not canceled and/or not filled) new order. The “cancel order” message may again either be acknowledged or rejected by the electronic trading system with a “cancel order acknowledgement” or a “cancel order reject” message, which would also be part of the order chain. An order chain may also include a “replace order” message sent by participant device 130, replacing the quantity and/or the price of a prior acknowledged (but still open) new order. The “replace order” message may again either be acknowledged or rejected by the electronic trading system with a “replace order acknowledgement” or a “replace order reject” message, which would also be part of the order chain. A prior acknowledged order that is still open may be matched with one or more counter orders of the opposite side (that is, “buy” on one side and “sell” or “sell short” on the other side), and the electronic trading system 100 may then generate a complete “fill” message (when all of the open order's quantity is filled in a single match) or one or more partial “fill” messages (when only a portion of the open order's quantity is filled in a single match), and these “fill” messages would also be part of the order chain. As discussed above, the reference sequence identifier, in general, may identify another prior message in the same order chain.

For example, returning to the reference sequence identifier field 110-15, the value for the reference sequence number may be the sequence number assigned by the sequencer for an “incoming” message originating from a participant device 130 and introduced into electronic trading system 100 by a gateway 120, such that a corresponding “outgoing” message, such as a response message generated by a compute node 140, may reference the sequencer number value of the incoming message to which it is responding. In this example, a “new order acknowledgement” message or a “fill” message generated by a compute node 140 would include in the reference sequence identifier field 110-15 the value for the sequence identifier assigned to the corresponding “new order” message to which the compute node 140 is responding with a “new order acknowledgement” message or fulfilling the order with the “fill” message. In general, however, the value for the reference sequence identifier field 110-15 need not necessarily be that of a message that is being directly responded to by the electronic trading system 100, but may be that of a prior message that is part of the same order chain, for example, the sequence number of a “new order” or a “new order acknowledgement.”

In some embodiments, at least for some message types, the gateways 120 may also populate the reference sequence identifier field 110-15 in messages they introduce into electronic trading system 100 with a value of a sequence identifier for a related prior message. For example, a gateway 120 may populate the reference sequence identifier field 110-15 in a “cancel order” or a “replace order” message with the value of the sequence identifier assigned to the prior corresponding “new order” or “new order acknowledgment” message. Similarly, core compute nodes 140 may also populate the sequence identifier field 110-15 for a corresponding “cancel order acknowledgement” message or “replace order acknowledgement” message with the value of the sequence identifier for the “new order” or “new order acknowledgment,” rather than that of the message to which the compute node 140 was directly responding (e.g., rather than the sequence identifier of the “cancel order” or “replace order” message). Again, the reference sequence identifier field 110-15 allows nodes in electronic trading system 100 generally to correlate a message with one or more prior messages in the same order chain.

A generating node may also include a node-specific timestamp field 110-13 in messages it introduces into electronic trading system 100. While the sequence identifier included in the sequence identifier field 110-14 of sequence-marked messages outputted by the sequencer 150 is intended to be unique throughout the electronic trading system 100, the value in the node-specific timestamp field 110-13 may be unique among a subset of messages, those messages introduced into electronic trading system 100 by a particular generating node. While referred to herein as a “timestamp,” a value placed in the node-specific timestamp field 110-13 may be any suitable value that is unique among messages generated by that node. For example, the node-specific timestamp may be in fact a timestamp or any suitable monotonically increasing or decreasing value.

Some embodiments may include other timestamp fields in the message format. For example, some message formats may include a reference timestamp field, which may be a timestamp value assigned by the generating node of a prior, related message. In such embodiments, a compute node 140 may include a new timestamp value in the node-specific timestamp field 110-13 for messages that it generates, and may also include a timestamp value from a related message in a reference timestamp field of the message the compute node generates. For example, a “new order acknowledgement” message generated by the compute node may include a timestamp value of the “new order” to which it is responding in the reference timestamp field of the “new order acknowledgement message.” Furthermore, in some embodiments, compute nodes 140 may not include a new timestamp value in the node-specific timestamp field 110-13 in messages they generate, but may simply populate that node-specific timestamp field 110-13 with a timestamp value from a prior related message.

The message format 110 may also include the entity type field 110-16 and entity count field 110-17. The entity type of a message may depend on whether it is introduced into the electronic trading system 100 by a gateway 120 or a compute node 140, or in other words, whether the message is an incoming message being received at a gateway 120 from a participant device 130 or whether it is an outgoing message being generated by a compute node 140 to be sent to a participant device 130. For example, in some embodiments, incoming messages are considered to be of entity type “flow,” (and the entity type field 110-16 is populated by the gateways 120 for incoming messages with a value representing the type “flow”), while outgoing messages are considered to be of entity type, “symbol,” (and the entity type field 110-16 is populated by the computed nodes 140 for outgoing messages with a value representing the type “symbol”). In such embodiments, the entity count of type “flow” is maintained by gateways 120, and the entity count of type “symbol” is maintained by the compute nodes 140.

Considering the entity type “flow,” a gateway 120 may maintain a per flow incoming message count, counting incoming messages received by the gateway 120 over each flow active on the gateway 120. For example, if four non-redundant flows are active on a gateway 120, each flow would be assigned a unique flow identifier, as discussed above, and the gateway 120 would maintain a per flow incoming message count, counting the number of incoming messages received over each of those four flows. In such embodiments, the gateway 120 populates the entity count field 110-17 of an incoming message with the per flow incoming message count associated with the incoming message's flow (as identified throughout the electronic trading system 100 by a flow identifier value, populated in the flow identifier field 110-12 of the message).

In the case of redundant flows in an active/active configuration, (that is, as discussed above, in which multiple flows receive the same messages, or at least, functionally equivalent messages, in parallel from participant device(s) 130 connected via one or more gateway(s) 120), each underlying redundant flow may be assigned the same flow identifier, yet a per-flow incoming message count may still be maintained separately for each redundant flow, especially when the redundant flows are implemented on separate gateways 120. Because it is the expectation that a participant device 130 will send the same set of messages in the same order (i.e., sequence) to the electronic trading system 100 over each of the redundant flows, it is also the expectation that the entity count assigned to functionally equivalent messages received over separate redundant flows should be identical. These functionally equivalent incoming messages may be forwarded by the gateway(s) 120 to sequencer 150 and the compute nodes 140. Accordingly, in such embodiments, the sequencer 150 and compute nodes 140 could receive multiple functionally equivalent incoming messages associated with the same flow identifier, but the sequencer 150 and compute nodes 140 could identify such messages as being functionally equivalent when the entity count is identical for multiple messages having the same flow identifier. In some embodiments, the sequencer 150 and compute nodes 140 may keep track, on a per flow basis, of the highest entity count that has been included in entity count field 110-17 of incoming messages associated with each flow, which allows the sequencer 150 and compute nodes 140 to take action only on the first to arrive of multiple incoming functionally equivalent messages each node has received, and to ignore other subsequently arriving functionally equivalent incoming messages. For example, the sequencer 150 may in some embodiments only sequence the first such functionally equivalent incoming message to arrive, and the compute nodes 140 may only start processing on the first such functionally equivalent message to arrive. If an incoming message received by a node (i.e., a sequencer 150 or a compute node 140) has an entity count that is the same or lower than the highest entity count the node has seen for that flow, then the node may assume that the incoming message is functionally equivalent to another previously received incoming message, and may simply ignore the subsequently received functionally equivalent incoming message.

Considering now the case of entity type “symbol,” a compute node 140 may maintain a per symbol outgoing message count, counting outgoing messages generated by and sent from the compute node 140 for each symbol serviced by the compute node 140. For example, if four symbols (e.g., MSFT, GOOG, IBM, ORCL) are serviced by a compute node 140, each symbol is assigned a symbol identifier populated in symbol field 110-2 of the message, as discussed above, and the compute node 140 would maintain a per symbol outgoing message count, counting the number of outgoing messages it generated and sent that serviced each of those four symbols. In such embodiments, the compute node 140 populates the entity count field 110-17 of an incoming message with the per symbol outgoing message count associated with the outgoing message's symbol (as identified throughout the electronic trading system 100 by the value populated in the symbol identifier field 110-2 of the message).

In some embodiments, as discussed further below, compute nodes may be configured such that multiple compute nodes service a particular symbol in parallel, for reasons of high availability. Because of the deterministic ordering of messages throughout electronic trading system 100 provided by the sequencer 150, it can be guaranteed that even when multiple compute nodes service a given symbol, they will be processing incoming messages referencing the same symbol in the same order (i.e., sequence) and in the same manner, thereby generating functionally equivalent response messages in parallel. When considering the outgoing messages being sent out for a particular symbol across multiple compute nodes 140, each outgoing message referencing that symbol should have a functionally equivalent message being sent out by each other compute node 140 actively servicing that symbol. These outgoing messages may all be sent by the compute nodes 140 to sequencer 150 and the gateways 120. Accordingly, in such embodiments, the sequencer 150 and gateways 120 could receive multiple functionally equivalent incoming messages associated with the same symbol, but the sequencer 150 and gateways 120 could identify such messages as being functionally equivalent when the entity count is identical for multiple messages having the same symbol identifier. In some embodiments, the sequencer 150 and gateways 120 may keep track, on a per symbol basis, of the highest entity count that has been included in entity count field 110-17 of outgoing messages associated with the symbol, which allows the sequencer 150 and gateways 120 to take action only on the first to arrive of multiple outgoing functionally equivalent messages each node has received, and to ignore other subsequently arriving functionally equivalent outgoing messages. For example, the sequencer 150 may in some embodiments only sequence the first such functionally equivalent outgoing message to arrive. Similarly, the gateways 120 may only start processing the first such functionally equivalent message to arrive. If an outgoing message received by a node (i.e., a sequencer 150 or a gateway 120) has an entity count that is the same or lower than the highest entity count the node has previously seen for that symbol, then the node may assume that the outgoing message is functionally equivalent to another previously received outgoing message, and may simply ignore the subsequently received functionally equivalent outgoing message.

In embodiments in which the sequencer 150 only sequences the first message of a plurality of functionally equivalent messages to arrive at the sequencer, the sequencer could do so in a variety of ways. In one example, other subsequently arriving messages that are functionally equivalent to that first such functionally equivalent message to arrive may simply be ignored by the sequencer (in which case only a single sequence marked message may be outputted by the sequencer for the set of functionally equivalent messages). Another possibility is for the sequencer to track a sequence number that it assigns to the first functionally equivalent message, for example, by making an association between the entity count of the message, its flow identifier or symbol identifier (for messages having entity types of “flow” and “symbol”, respectively), and its sequence number, such that the sequencer may output a sequenced version of each functionally equivalent message in which the value of the sequence identifier field 110-14 for all the sequence-marked versions of the functionally equivalent messages is the same as had been assigned by the sequencer to the first message to arrive among the functionally equivalent messages received by the sequencer 150.

In other embodiments, the sequencer 150 may not keep track of whether messages are functionally equivalent, and may assign each unsequenced message that arrives at the sequencer 150 a unique sequence number, regardless of whether that message is among a plurality of functionally equivalent messages. In such embodiments, the sequence-marked versions of messages among a plurality of functionally equivalent messages are each assigned different sequence identifiers by the sequencer as the value in the sequencer identifier field 110-14. To determine an effective sequence identifier for the set of functionally equivalent messages, the recipient node of sequenced functionally equivalent messages in such embodiments may use the sequence identifier in the sequenced version of the message among the sequenced functionally equivalent messages that is first to arrive at the node. In embodiments in which there are direct point-to-point connections among the nodes in the electronic trading system 100, sequence-marked versions of the messages are sent out in sequenced order by the sequencer 150, and accordingly, should be received in the same sequenced order among all nodes directly connected to the sequencer. Therefore, for all nodes receiving the sequence-marked messages via respective direct point-to-point connections with the sequencer, the first sequence-marked message to arrive among a plurality of functionally equivalent sequence-marked messages should have the same value in the sequence identifier field 110-14.

As may be apparent from the discussion above, in embodiments having a message format, such as the message format 110, besides a message's sequence identifier, there may exist multiple other ways of uniquely identifying a message throughout electronic trading system 100. For example, in embodiments in which a message includes both a node identifier and a node-specific timestamp, the presence of these two identifiers in a message may be sufficient to uniquely identify the message throughout electronic trading system 100. Such fields may be understood as including metadata and multiple messages including such identical metadata may be understood as including common metadata. Similarly, in embodiments in which a flow identifier is unique throughout electronic trading system 100, a combination of a message's flow identifier and node specific timestamp may be sufficient to uniquely identify the message throughout electronic trading system 100. Furthermore, a combination of a flow identifier and entity count could be sufficient to uniquely identify a message of entity type “flow,” and a combination of a symbol identifier and entity count could be sufficient to uniquely identify a message of entity type “symbol.”

It should be noted, however, that while there may exist other ways besides the sequence identifier assigned to a message of uniquely identifying the message throughout electronic trading system 100, the sequence identifier is still necessary in order to specify in a fair and deterministic manner the relative ordering of the message among other messages generated by other nodes throughout electronic trading system 100. For example, if the node-specific timestamp is in fact implemented as a timestamp value, even if system clocks among nodes are perfectly synchronized, two different messages, each generated by a different node, may each be assigned the same timestamp value by their respective generating node, and the relative ordering between these two messages is then ambiguous. Even if the messages can be identified uniquely, a recipient node of both messages would still need a way to determine the relative ordering of the two messages before taking possible action on the messages.

One possible approach for a recipient node to resolve that ambiguity could be through the use of randomness, for example, by randomly selecting one message as preceding the other in the relative ordering of messages throughout the electronic trading system 100. Using randomness to resolve the ambiguity, however, does not support “state determinism” throughout the electronic trading system 100. Different recipient nodes may randomly determine a different relative ordering among the same set of messages, resulting in unpredictable, nondeterministic behavior within electronic trading system 100, and impeding the correct implementation of important features, such as fault-tolerance, high availability, and disaster recovery.

Another approach for a recipient node to resolve the ambiguity in ordering could be through a predetermined precedence method, for example, based on the node identifier associated with the message. Such an approach, however, works against the important goal of fairness, by giving some messages higher precedence simply based on the node identifier of the node that introduced the message into electronic trading system 100. For example, some participant devices 130 could be favored simply because they happen to be connected to the electronic trading system 100 over a gateway 120 that is deemed higher in the predetermined precedence method.

If messages were to be uniquely identified via the entity count and either symbol identifier or flow identifier, depending on whether the message has an entity type of “symbol,” or “flow,” respectively, there may be a deterministic ordering among other messages associated with that symbol (in the case of a message having entity type of “symbol”) or that flow (in the case of a message having an entity type of “flow”). The ordering, however, among other messages associated with different symbols and flows, respectively, would still be non-deterministic.

Accordingly, even if other fields in the message format 100 may be sufficient to uniquely identify a message throughout the electronic trading system 100, the sequence identifier assigned to a message by the sequencer 150 may still be required in order to fairly and deterministically specify the ordering of a message relative to other messages in the electronic trading system 100. In such embodiments, the sequencer 150 (or the single currently active sequencer, if multiple sequencers 150 are present) serves as the authoritative source of a truly deterministic ordering among sequence-marked messages throughout the electronic trading system 100.

In some embodiments, nodes in electronic trading system 100 may receive two versions of a message: an unsequenced (unmarked) version of the message as introduced into the electronic trading system 100 by the generating node, and a (marked) version of the message that includes a sequence identifier assigned by the sequencer 150. This may be the case in embodiments in which a generating node sends the unmarked message to one or more recipient nodes as well as the sequencer 150. The sequencer 150 may then send a sequence-marked version of the same message to a set of nodes including the same recipient nodes.

While, as discussed above, the sequence-marked version of the message is useful for determining the relative processing order (i.e., position in a sequence) of the message among other marked messages in electronic trading system 100, it may also be useful for a recipient node to receive the unmarked version of the message. For example, it is certainly possible, if not expected, (for example, in embodiments in which there are direct connections between nodes), for the unmarked version of the message to be received prior to the marked version of the message, because the marked version of the message is sent via an intervening hop through sequencer 150. Accordingly, there is the opportunity, in some embodiments, for a recipient node to activate processing of the unmarked message upon receiving the unmarked message even before that recipient node has received the marked version of the message which authoritatively indicates the relative ordering of the marked message among other marked messages.

A node receiving both the marked and unmarked versions of a same message may correlate the two versions of the message to each other via the same identifying information or “common metadata,” in both versions of the message. For example, as discussed above, a generating node may include in messages it generates (i.e., unmarked messages) a node identifier and a node specific timestamp, which together, may uniquely identify each message throughout electronic trading system 100. In embodiments in which the marked and unmarked versions of a message are essentially identical except for the sequence identifier assigned by sequencer 150, the marked message may also include the same node identifier and node specific timestamp that are also included in the corresponding unmarked message, thereby allowing a recipient node of both versions of the message to correlate the marked and unmarked versions. Accordingly, while the marked messages directly indicate relative ordering of a marked message relative to the other marked messages throughout electronic trading system 100, because of the correlation that may be made between the unmarked and marked version of the same message, marked messages, (at least indirectly via the correlation discussed above), indicate the relative ordering of the message relative to other messages (marked or unmarked) throughout electronic trading system 100. It should be understood that nodes in electronic trading system 100 may also correlate sequence marked with unmarked versions of the messages by means of the other manners of uniquely identifying messages discussed above. For example, a correlation between sequence marked and unmarked messages may be made by means of a combination of a flow identifier and a node specific timestamp. Such a correlation may additionally or alternatively be made by means of a message's entity count along with the symbol identifier or flow identifier in the message, for messages having entity type “symbol” and “flow,” respectively.

In the era of high-speed trading, in which microseconds or even nanoseconds are consequential, participant devices 130 exchanging messages with the electronic trading system 100 are often very sensitive to latency, preferring low, predictable latency. The arrangement shown in FIG. 1D accommodates this requirement by providing a point-to-point mesh 172 architecture between at least each of the gateways 120 and each of the compute nodes 140. In some embodiments, each gateway 120 in the mesh 172 may have a dedicated high-speed direct connection 180 to the compute nodes 140 and the sequencers 150.

For example, the dedicated connection 180-1-1 is provided between the gateway 120-1 (i.e., GW 1) and core compute node 140-1 (i.e., Core 1), the dedicated connection 180-1-2 is provided between the gateway 120-1 (i.e., GW 1) and compute node 140-2 (i.e., Core 2), and so on, with example connection 180-g-c provided between gateway 120-g and compute node 140-c, example connection 180-s-c provided between sequencer 150 and core compute node 140-c (i.e., Core c), example connection 180-gw1-s1 provided between the gateway 120-1 (i.e., GW g) and sequencer 150-1, and example connection 180-c1-s1 provided between the core compute node 140-1 (i.e., Core 1) and sequencer 150-1.

It should be understood that each dedicated connection 180 in the point-to-point mesh 172 is, in some embodiments, a point-to-point direct connection that does not utilize a shared switch. A dedicated or direct connection may be referred to interchangeably herein as a direct or dedicated “link” and is a direct connection between two end points that is dedicated (e.g., non-shared) for communication therebetween. Such a dedicated/direct link may be any suitable interconnect(s) or interface(s), such as disclosed further below, and is not limited to a network link, such as wired Ethernet network connection or other type of wired or wireless network link. The dedicated/direct connection/link may be referred to herein as an end-to-end path between the two end points. Such an end-to-end path may be a single connection/link or may include a series of connections/links; however, bandwidth of the dedicated/direct connection/link in its entirety, that is, from one end point to another end point, is non-shared and neither bandwidth nor latency of the dedicated/direct connection/link can be impacted by resource utilization of element(s) if so traversed. For example, the dedicated/direct connection/link may traverse one or more buffer(s) or other elements that are not bandwidth or latency impacting based on utilization thereof. The dedicated/direct connection/link would not, however, traverse a shared network switch as such a switch can impact bandwidth and/or latency due to its shared usage.

For example, in some embodiments, the dedicated connections 180 in the point-to-point mesh 172 may be provided in a number of ways, such as a 10 Gigabit Ethernet (GigE), 25 GigE, 40 GigE, 100 GigE, InfiniBand, Peripheral Component Interconnect-Express (PCIe), RapidIO, Small Computer System Interface (SCSI), FireWire, Universal Serial Bus (USB), High Definition Multimedia Interface (HDMI), or custom serial or parallel busses. Therefore, although the compute engines 140, gateways 120, sequencers 150, and other components may sometimes be referred to herein as “nodes,” the use of terms such as “compute node” or “gateway node” or “sequencer node” or “mesh node” should not be interpreted to mean that particular components are necessarily connected using a network link, since other types of interconnects or interfaces are possible. Further, a “node,” as disclosed herein, may be any suitable hardware, software, firmware component(s), or combination thereof, configured to perform the respective function(s) set forth for the node. As explained in more detail below, a node may be a programmed general purpose processor, but may also be a dedicated hardware device, such as a field programmable gate array (FPGA), application specific integrated circuit (ASIC), or other hardware device or group of devices, logic within a hardware device, printed circuit board (PCB), or other hardware component.

It should be understood that nodes disclosed herein may be separate elements or may be integrated together within a single element, such as within a single FPGA, ASIC, or other element configured to implement logic to perform the functions of such nodes as set forth herein. Further, a node may be an instantiation of software implementing logic executed by general purpose computer and/or any of the foregoing devices.

Conventional approaches to connecting components, such as the compute engines 140, gateways 120, and sequencers 150 through one or more shared switches, do not provide the lowest possible latency. These conventional approaches also result in unpredictable spikes in latency during periods of heavier message traffic.

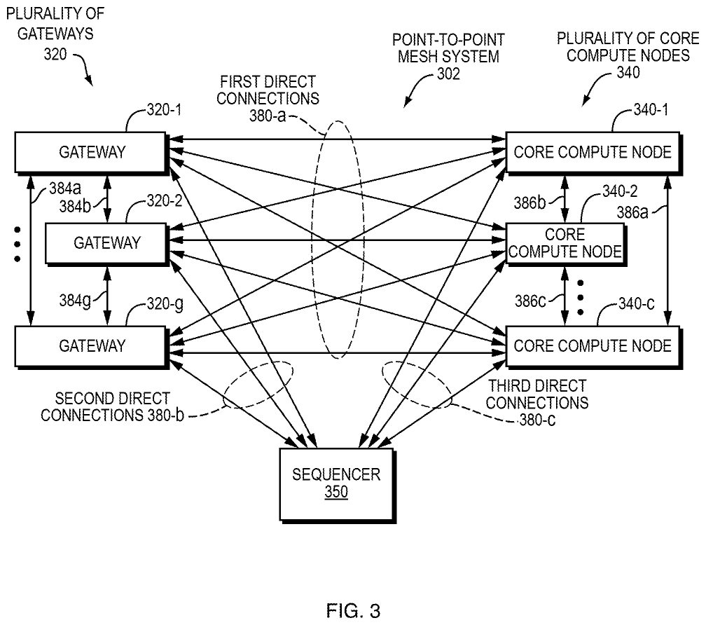

In an example embodiment, dedicated connections 180 are also provided directly between each gateway 120 and each sequencer 150, and between each sequencer 150 and each core compute node 140. Furthermore, in some embodiments, dedicated connections 180 are provided among all the sequencers, so that an example sequencer 150-1 has a dedicated connection 180 to each other sequencer 150-2, . . . , 150-s. While not pictured in FIG. 1D, in some embodiments, dedicated connections 180 may also be provided among all the gateways 120, so that each gateway 120-1 has a dedicated connection 180 to each other gateway 120-2, . . . , 120-g, such as disclosed further below with regard to FIG. 3. Similarly, in some embodiments, dedicated connections 180 are also provided among all the compute nodes 140, so that an example core compute node 140-1 has a dedicated connection 180 to each other core compute node 140-2, . . . , 140-c, such as disclosed further below with regard to FIG. 3.

It should also be understood that a dedicated connection 180 between two nodes (e.g., between any two nodes 120, 150, or 140) may in some embodiments be implemented as multiple redundant dedicated connections between those same two nodes, for increased redundancy and reliability. For example, the dedicated connection 180-1-1 between the gateway 120-1 and core compute node 140-1 may actually be implemented as a pair of dedicated connections.

In addition, according to some embodiments, any message sent out by a node is sent out in parallel to all nodes directly connected to it in the point-to-point mesh 172. Each node in the point-to-point mesh 172 may determine for itself, for example, based on the node's configuration, whether to take some action upon receipt of a message, or whether instead simply to ignore the message. In some embodiments, a node may never completely ignore a message; even if the node, due to its configuration, does not take substantial action upon receipt of a message, it may at least take minimal action, such as consuming any sequence number assigned to the message by the sequencer 150. That is, in such embodiments, the node may keep track of a last received sequence number to ensure that when the node takes more substantial action on a message, it does so in proper sequenced order.

For example, a message containing a trade order to “Sell 10 shares of Microsoft at $190.00” might originate from the participant device 130-1, such as a trader's personal computer, and arrive at gateway 120-1 (i.e., GW 1). That message will be sent to all core compute nodes 140-1, 140-2, . . . , 140-c even though only core compute node 140-2 is currently performing matching for Microsoft orders. All other core compute nodes 140-1, 140-3, . . . , 140-c may upon receipt ignore the message or only take minimal action on the message. For example, the only action taken by 140-1, 140-3, . . . , 140-c may be to consume the sequence number assigned to the message by the sequencer 150-1. That message will also be sent to all of the sequencers 150-1, 150-2, . . . , 150-s even though a single sequencer (in this example, sequencer 150-1) is the currently active sequencer servicing the mesh. The other sequencers 150-2, . . . , 150-s also received the message to allow them the opportunity to take over as the currently active sequencer should sequencer 150-1 (the currently active sequencer) fail, or if the overall reliability of the electronic trading system 100 would increase by moving to a different active sequencer. One or more of the other sequencers (sequencer 150-2 for example) may also be responsible for relaying system state to the disaster recovery site 155. The disaster recovery site 155 may include a replica of the electronic trading system 100 at another physical location, the replica comprising physical or virtual instantiations of some or all of the individual components of the electronic trading system 100.

By sending each message out in parallel to all directly connected nodes, the electronic trading system 100 reduces complexity and also facilitates redundancy and high availability. If all directly connected nodes receive all messages by default, multiple nodes can be configured to take action on the same message in a redundant fashion. Returning to the example above of the order to “Sell 10 shares of Microsoft at $190.00,” in some embodiments, multiple core compute nodes 140 may simultaneously perform matching for Microsoft orders. For example, both the core compute node 140-1 and core compute node 140-2 may simultaneously perform matching for Microsoft messages, and may each independently generate, after having received the incoming message of the “Sell” order, a response message, such as an acknowledgement or execution message, that each of core compute node 140-1 and core compute node 140-2 sends to the gateways 120 through the sequencer(s) 150 to be passed on to one or more participant devices 130.

Because of the strict ordering and state determinism assured by the sequencer(s) 150, it is possible to guarantee that each of the associated response messages independently generated by and sent from the core compute nodes 140-1 and 140-2 are substantially and functionally equivalent; accordingly, the architecture of the electronic trading system 100 readily supports redundant processing of messages, which increases the availability and resiliency of the system. In such embodiments, gateways 120 may receive multiple associated outgoing messages from core compute nodes 140 for the same corresponding incoming message. Due to the fact that it can be guaranteed that these multiple associated response messages are equivalent, the gateways 120 may simply process only the first received outgoing message, ignoring subsequent associated outgoing messages corresponding to the same incoming message. In some embodiments, the “first” and “subsequent” messages may be identified by their associated sequence numbers, as such messages may be sequence-marked messages. Although, in other embodiments, such as those in which the sequencer 150 assigns a single sequence identifier among a plurality of functionally equivalent messages, messages may be identified as being functionally equivalent based on other identifying information in the messages, such as the values in the entity type field 110-16 and entity count field 110-17, as discussed further in connection with FIG. 1E above.

Allowing the gateways 120 to take action on the first of several functionally equivalent associated response messages to reach them may, therefore, also improve the overall latency of the electronic trading system 100. Furthermore, the electronic trading system 100 can be easily configured such that any incoming message is processed by multiple compute nodes 140, in which each of those multiple compute nodes 140 generates an equivalent response message that can be processed by the gateways 120 on a first-to-arrive basis. Such an architecture provides for high availability with no perceptible impact to latency in the event that a compute node 140 is not servicing incoming messages for a period of time (whether due to a system failure, a node reconfiguration, or a maintenance operation).

Such a point-to-point mesh 172 architecture of the electronic trading system 100, besides supporting low, predictable latency and redundant processing of messages, also provides for built-in redundant, multiple paths. As can be seen, there exist multiple paths between any gateway 120 and any compute node 140. Even if a direct connection 180-1-1 between gateway 120-1 and compute node 140-1 becomes unavailable, communication is still possible between those two elements via an alternate path, such as by traversing one of the sequencers 150 instead. Thus, more generally speaking, there exist multiple paths between any node and any other node in the point-to-point mesh 172.

Furthermore, this point-to-point mesh architecture inherently supports another important goal of a financial trading system, namely, fairness. The point-to-point architecture with direct connections between nodes ensures that the path between any gateway 120 and any core compute node 140, or between the sequencer 150 and any other node has identical or, at least very similar latency. Therefore, two incoming messages sent out to the sequencer 150 at the same time from two different gateways 120 should reach the sequencer 150 substantially simultaneously. Similarly, an outgoing message being sent from a core compute node 140 is sent to all gateways 120 simultaneously, and should be received by each gateway at substantially the same time. Because the topology of the point-to-point mesh does not favor any single gateway 120, chances are minimized that being connected to a particular gateway 120 may give a participant device 130 an unfair advantage or disadvantage.

Additionally, the point-to-point mesh architecture of the electronic trading system 100 allows for easily reconfiguring the function of a node, that is, whether a node is currently serving as a gateway 120, core compute node 140 or sequencer 150. It is particularly easy to perform such reconfiguration in embodiments in which each node has a direct connection between itself and each other node in the point-to-point mesh. When each node is connected via a direct connection to each other node in the mesh, no re-wiring or re-cabling of connections 180 (whether physical or virtual) within the point-to-point mesh 172 is required in order to change the function of a node in the mesh (for example, changing the function of a node from a core compute node 140 to a gateway 120, or from a gateway 120 to a sequencer 150). In such embodiments, the reconfiguration required that is internal to the point-to-point mesh 172 may be easily accomplished through configuration changes that are carried out remotely. In the case of a node being reconfigured to serve as a new gateway 120 or being reconfigured from serving as a gateway 120 to another function, there may be some ancillary networking changes required that are external to the point-to-point mesh 172, but the internal wiring of the mesh may remain intact.

Accordingly, in some embodiments, the reconfiguration of the function of a node may be accomplished live, even dynamically, during trading hours. For example, due to changes on characteristics of the load of the electronic trading system 100 or new demand, it may be useful to reconfigure a core compute node 140-1 to instead serve as an additional gateway 120. After some possible redistribution of state or configuration to other compute nodes 140, the new gateway 120 may be available to start accepting new connections from participant devices 130.

In some embodiments, lower-speed, potentially higher latency shared connections 182 may be provided among the system components, including among the gateways 120 and/or the core compute nodes 140. These shared connections 182 may be used for maintenance, control operations, management operations, and/or similar operations that do not require very low latency communications and, in contrast to messages related to trading activity carried over the dedicated connections 180 in the point-to-point mesh 172, such as the message 106 and response 107 disclosed above with regard to FIG. 1B-2. In contrast to the first direct connections 180-a, second direct connections 180-b, and third direct connections 180-c that carry traffic related to trading activity, the shared connections 182g and 182c carry non-trading activity type traffic. Shared connections 182, carrying non-trading traffic, may be over one or more shared networks and via one or more network switches, and nodes in the mesh may be distributed among these shared networks in different ways. For example, in some embodiments, gateways 120 may all be in a gateway-wide shared network 182-g, compute nodes 140 may be in their own respective compute node-wide shared network 182-c, and sequencers 150 may be in their own distinct sequencer-wide shared network 182-s, while in other embodiments all the nodes in the mesh may communicate over the same shared network for these non-latency sensitive operations.

Distributed computing environments, such as electronic trading system 100, sometimes rely on high resolution clocks to maintain tight synchronization among various components. To that end, one or more of the nodes 120, 140, 150 might be provided with access to a clock, such as a high-resolution global positioning system (GPS) clock 195 in some embodiments. For purposes of the following discussion, gateways 120, compute nodes 140, and sequencers 150 connected in the point-to-point mesh 172 may be referred to as “Mesh Nodes,” and may have an architecture, such as disclosed further below with regard to FIG. 2.

FIG. 1F is a flow diagram of an example embodiment of a process 125 that may be carried out by the electronic trading system 100 to process a message. With reference to FIG. 1B-2, the gateway 120-1 may receive (131) a message from a participant device, and, in turn, send (132) the message 106 to the sequencer 150-1 and the compute node 140-1. The gateway 120-1 may optionally include an identifier generated by the gateway 120-1 in the message 106, and, in an electronic trading system comprising multiple compute nodes and/or sequencers, the gateway 120-1 may send the message 106 to all such nodes. The compute node 140-1, upon receipt of the message 106, may first determine whether the message 106 is one that the compute node 140-1 is assigned to process, and may make this determination based on one or more values or identifiers of the message 106 (e.g., a value of a common parameter, such as a symbol representing a given financial instrument or a type of transaction). If assigned to process the message 106, the compute node 140-1 may then perform preprocessing (134) on the message 106 to generate a preliminary result. For example, the compute node 140-1 may load into memory information relating to a value (e.g., symbol for a financial instrument) referenced in the message 106. Alternatively, or additionally, in some embodiments, the preprocessing may include performing a matching function, such as generating a response message including an acknowledgement message or an execution message, making preliminary updates to an order book for a value (e.g., symbol for a financial instrument) referenced in the message 106, etc., for non-limiting example. Such preprocessing may be conducted such that it has no adverse side effects, or may, if necessary, be atomically (i.e., transaction-by-transaction basis) “rolled back” if it is later determined that the message on which preprocessing was performed had been received out of order.

Concurrently, the sequencer 150-1 may sequence the message 106, for example by associating (133) the message 106 with a unique sequence identifier that enables a position of the message 106 to be identified within a sequence of messages, which may be required to be processed in a given order (i.e., sequence), and generate a sequence-marked version of the message 106, that is, the sequence-marked message 106′. Once complete, the sequencer 150-1 may send (135) the sequence-marked message 106′ that includes the message 106 (or representation thereof) and sequence identifier to the compute node 140-1. Once the compute node 140-1 receives the sequence-marked message 106′, it may, in some embodiments, determine whether the (unsequenced) message 106 on which it performed its preprocessing was received in order, that is, it may verify (136) the sequence. As part of verifying the sequence, the compute node 140-1 may correlate the message 106 to the sequence-marked message 106′ by means of common metadata or common identifying information in both versions of the message. In the process 125 of the example embodiment, the message 106 was received in order, and the compute node 140-1 can proceed to continue processing (137) the message 106. As a result of the preprocessing, the compute node 140-1 may have already completed some operations that it would have performed after receiving the sequence-marked message 106′ (e.g., a cache memory lookup of a value), thereby enabling the compute node 140-1 to complete processing the message 106 sooner than it would have without the preprocessing operation.

FIG. 1G is a flow diagram of an example embodiment of a process 165 illustrating another example embodiment of operation of an electronic trading system. The process 165 may be carried out by the electronic trading system 100 to process a message. In the embodiment of FIG. 1G, the electronic trading system 100 includes at least a second gateway, the gateway 120-2. With reference to FIG. 1B-2, the gateway 120-1 may receive (166) a first message (M1) from a participant device, and, in turn, send (167) a message 106 corresponding to the first message M1 to the sequencer 150-1 and the compute node 140-1. The message 106 may also be referred as the first message M1, however, it should be understood that the message 106 may not be identical to M1 as the gateway may have modified same to include different metadata, such as an identifier of the gateway 120-1 for non-limiting example. The gateway 120-2 may receive (168) a second message (M2) from another participant device, and send (169) a message corresponding to the second message M2 to the sequencer 150-1 and the compute node 140-1. The message corresponding to the second message M2 may also be referred to herein as the second message M2. In this example, the first and second messages belong to a common sequence of messages, such that the relative order (i.e., sequence) in which the first and second messages are processed could affect the state of the electronic trading system 100. In the example embodiment of FIG. 1G, the compute node 140-1 receives the second message before receiving the first message and, upon confirming that the second message is one that the compute node 140-1 is assigned to process, the compute node 140-1 may then perform preprocessing (171) on the message. Upon receiving the first message (M1), the compute node 140-1 may also perform preprocessing (173) on the first message (M1).

The sequencer 150-1 may receive both the first and second messages. The sequencer 150-1 may then assign to each of the first and second messages respective unique sequence identifiers that may be used to determine the relative ordering or sequence of the first and second messages (170, 174). In some embodiments, the sequence identifier assigned by the sequencer to the message may be a monotonically increasing sequence number for non-limiting example. Furthermore, in some embodiments, the value of the sequence identifier assigned to a message by the sequencer may be based on the arrival time of the message at the sequencer 150-1. That is, in some embodiments and for non-limiting example, messages are placed in a First-In-First-Out (FIFO) queue as they are received by the sequencer 150-1, and are assigned the sequence identifier as they are removed from the FIFO queue. In the example embodiment of FIG. 1G, the message M1 was received at the sequencer 150-1 earlier than the message M2 and, therefore, in embodiments in which the sequence identifier is a monotonically increasing sequence number, message M1 may be assigned a lower sequence number by the sequencer 150-1 relative to another sequence number assigned to the message M2. Once the process of assigning a sequence identifier to each message is complete, the sequencer 150-1 may send marked messages (that is, messages including the sequence identifiers) corresponding to the first and second messages, or a representation, thereof, to the compute node 140-1 (175, 177). In some embodiments, once the compute node 140-1 receives the marked messages, it may determine whether the (unsequenced) message 106 on which it performed its preprocessing was received in order, that is, may verify (176) the sequence. As part of verifying the sequence, the compute node 140-1 may correlate the unsequenced message 106 to the sequence-marked message 106′ by means of common metadata or common identifying information in both versions of the message. In the process 165, the compute node 140-1 received the second message out of order. In such a result, some or all of the product of the preprocessing (e.g., the cache lookup for the value of a common parameter of the message for non-limiting example) may optionally be discarded or, for other types of preprocessing, atomically rolled back. The compute node 140-1 may then proceed to process (178) both the first and second messages in the order (i.e., sequence) as indicated by the sequencer 150-1.

Even if it is determined that an unsequenced message was received out of order at the compute node 140-1, the node 140-1 may still benefit from performing preprocessing on the message. By preprocessing the message, the compute node 140-1 has determined that it will likely need to process this message in the future, and can take time-saving, preemptive action, accordingly. For example, information needed to completely process the message, such as information about current open trade orders for the same stock symbol, may need to be resident in a faster memory (e.g., FPGA memory, such as Fixed Logic Memory 250 illustrated in FIG. 2, or other cache memory) before the message can be fully processed, and if not yet resident in the faster memory, may first require retrieval from a slower memory (e.g., hard disk or DRAM, such as DRAM 280 illustrated in FIG. 2). For a value of a common parameter, such as a stock symbol of the message that has not been referenced recently, this information may not be currently resident in the faster memory, yet the compute node 140-1 may carry out the memory copy operation in advance even in the event of an out-of-sequence message, thereby saving time when the sequenced message arrives in proper order (i.e., sequence) soon thereafter. Provided that the faster memory is sufficiently large to hold information for multiple values, receiving even a string of multiple consecutive out-of-order messages may be beneficial by enabling the compute node to prefetch information for a number of values in advance. Thus, rather than disregarding the results of a preprocessing operation, the compute node 140-1 may temporarily preserve the results for reference during a later processing operation.

In some example embodiments, the product of preprocessing by a compute node may still be valid in instances that do not conform to sequential ordering. For example, in an embodiment in which each computing node services a subset of operations, such as a subset of values of a common parameter of the messages (e.g., a limited number of stock symbols or other indicators of financial instruments), the computing node may still receive messages that reference other stock symbols it does not service, yet the order of the sequence may only be relevant to the compute node insofar as it affects values that it services. Further, the ordering of messages referencing different values may be considered independent from one another. For example, if a message is received out of order relative to another message referencing a different value of a stock symbol, the sequence in which these two messages are processed may not affect the result of the matching function operation, so no further action regarding the preprocessing (e.g., a rollback) may be necessary, and the preprocessed result may eventually be used without modification and/or committed to the state of the distributed system.

In some embodiments, it should be understood that verifying the sequence (136 in FIG. 1F and 176 in FIG. 1G) may not be necessary, depending on the nature of the preprocessing performed by the compute node 140-1. For example, if the preprocessing performed on the unsequenced message has no adverse side effects and would not affect the result of the processing of other messages (e.g., loading into a faster memory data related to a symbol referenced in the message), there may be no need to verify that the preprocessing of the unsequenced message was done in accordance with the sequence determined by the sequencer 150-1, and there may certainly be no need to discard or atomically roll back the results of the preprocessing. In such embodiments, the compute node 140-1 may simply then complete the processing of the message upon receiving the sequence-marked message 106′, in the sequence order specified by the sequence identifier in the sequence-marked message 106′, all the while leveraging the preprocessed results.

The amount of preprocessing that may be done for an unsequenced message, and whether or not the results of that preprocessing may need to be discarded or rolled back, may depend on fields in the message, such as the message type field 110-1, symbol field 110-2, side field 110-3, or price field 110-4, according to the embodiment of FIG. 1E. It may also depend on whether other unsequenced messages are currently outstanding (that is, for which the corresponding sequence-marked message has not yet been received) that reference the same value for a common parameter in the message, such as the same stock symbol.

For example, if an unsequenced message with a message type of “new order” is received by core compute node 140-1, the core compute node 140-1 may load the symbol information relating to the relevant section of the order book into a fast memory, and if the new order would be a match for an open order in the order book, the compute node 140-1 may start to generate a “fill” message, accordingly, but hold off on committing an order book update and on sending the “fill” message out until it receives the sequenced version of that message. However, if the compute node 140-1 had also received another outstanding unsequenced “new order” message referencing the same stock symbol, side, price, etc, such that it is also a potential match for the same open order in the order book, the core compute node 140-1 may perform its preprocessing differently. In some embodiments, the core compute node 140-1 may generate competing potential “fill” messages, for each of the two outstanding unsequenced “new order” messages that could serve as a match for the open order. Based on the sequenced version of the messages, one of the potential “fill” messages may be discarded, while the other would be committed to the order book and sent out to the gateways 120. In other embodiments, when more than one possible outstanding unsequenced message could potentially match the same open order, the compute node 140-1 may not perform any preprocessing that may need to be discarded or rolled back (e.g., may not create any potential “fill” messages), or it may abort or pause any such preprocessing for those outstanding unsequenced messages.

As another example, an outstanding unsequenced “new order” message that is a potential match for an open order in the order book could be competing with an outstanding unsequenced “replace order” message or “cancel order” message attempting to replace or cancel, respectively, the same open order in the order book that would serve as a potential match to the “new order” message. In such a case, depending on the relative sequence assigned by the sequencer of the “new order” message versus the “replace/cancel order” message, the end result could either culminate in a match between the open order in the order book and the “new order” message, or it could instead culminate in that open order being canceled or replaced by a new order with a different price or quantity. Until the sequence-marked versions of the competing outstanding unsequenced messages are received from the sequencer 150-1, the compute node 140-1 cannot determine which of these two outcomes should result.

In such instances, the compute node 140-1 may perform preprocessing in different ways. In some embodiments, when there are multiple competing outstanding unsequenced messages, the compute node 140-1 may simply perform preprocessing that would not need to be rolled back or discarded, such as loading into faster memory a relevant section of the order book relating to a symbol referenced in both competing messages. In other embodiments, the compute node 140-1 may perform additional preprocessing, such as forming up one or more provisional potential responses, each corresponding to one of the multiple competing scenarios. For example, the compute node 140-1 may create a potential “fill” message and/or a potential “replace acknowledgement” message or “cancel acknowledgement” message, and possibly also make provisional updates to the order book corresponding to one or more of the multiple possible outcomes. While in some embodiments, the compute node 140-1 may perform this additional preprocessing for all such competing scenarios, in other embodiments, the compute node 140-1 may only perform additional preprocessing on one of, or a subset of, the competing scenarios. For example, the compute node 140-1 may perform the additional preprocessing on an outstanding unsequenced message only if there are no other outstanding competing unsequenced messages. Alternatively, or additionally, the compute node 140-1 may prioritize the performing of additional preprocessing for outstanding competing unsequenced messages according to the amount of time and/or complexity involved in rolling back or discarding the results of the preprocessing. Upon receiving the sequence-marked versions of the outstanding unsequenced messages, the compute node 140-1 may then determine the sequence (as assigned by the sequencer 150-1) in which the outstanding unsequenced messages should be processed, and complete the processing of the messages in that sequence, which may in some embodiments include rolling back or discarding one or more results of the preprocessing.

Besides the types of preprocessing already discussed above, in some embodiments the compute node 140-1 may additionally or alternatively perform preprocessing related to validation of the message to determine whether to accept or reject the message. For example, the preprocessing could include performing real-time risk checks on the message, such as checking that the price or quantity specified in the message does not exceed a maximum value (i.e., “max price check” or “max quantity check”), that the symbol in the message is a known symbol (i.e., “unknown symbol check”), that trading is currently permitted on that symbol (i.e., “symbol halt check”), or that the price is specified properly according to a correct number of decimal places (i.e., “sub penny check”). In some embodiments, the type of preprocessing could also include a “self trade prevention” validation check, to prevent a particular potential match from resulting in a self-trade in which a trading client matches against itself, if “self trade prevention” is enabled for the particular client or trade order. If a trade order fails one or more of these validation checks, the electronic trading system 100 may respond with an appropriate reject message. It should be understood that, even though these validation checks are described in the embodiments above as being performed by the compute node 140-1, at least some of these types of validation checks could in some embodiments be performed alternatively or additionally by a gateway 120 or other nodes in the electronic trading system 100.

In further embodiments, it may be beneficial or required for the gateway 120-1 to be informed of the unique system-wide sequence identifier associated with a message that originated from a client. This information may enable the gateway 120-1 to match up the original incoming message to the unique sequence number, which is used to ensure proper ordering of messages throughout the electronic trading system 100. Such a configuration at the gateway(s) may be required for the electronic trading system 100 to achieve state determinism and to provide fault-tolerance, high availability, and disaster recoverability with respect to the activity in the gateways. One solution for configuring the gateway 120-1 to maintain information on the sequence identifier associated with an incoming message is for the gateway 120-1 to wait for a response back from the sequencer 150-1 with the sequence identifier before forwarding the message to the compute node 140-1. Such an approach may add latency to the processing of messages. In a further example, in addition to forwarding to the compute node 140-1 a sequence-marked message it had originally received from the gateway 120-1, the sequencer 150-1 may also send, in parallel, the sequence-marked message (e.g., the marked message 106′ as shown in FIG. 1B-2) to the gateway 120-1. As a result, the gateway 120-1 may maintain information on the sequence identifier while minimizing latency at the electronic trading system 100.

FIG. 2 is a block diagram of an example embodiment of a Mesh Node in a point-to-point mesh architecture of an electronic trading system, such as the electronic trading system 100, disclosed above. FIG. 2 illustrates an example embodiment of a Mesh Node 200 in the point-to-point mesh 172 architecture of the electronic trading system 100. Mesh node 200 could represent a gateway 120, a sequencer 150, or a core compute node 140, for example. Although in this example, functionality in the Mesh Node 200 is distributed across both hardware and software, Mesh Node 200 may be implemented in any suitable combination of hardware and software, including pure hardware and pure software implementations, and in some embodiments, any or all of gateways 120, compute nodes 140, and/or sequencers 150 may be implemented with commercial off-the-shelf components.

In the embodiment illustrated by FIG. 2, in order to achieve low latency, some functionality is implemented in hardware in Fixed Logic Device 230, while other functionality is implemented in software in Device Driver 220 and Mesh Software Application 210. Fixed Logic Device 230 may be implemented in any suitable way, including an Application-Specific Integrated Circuit (ASIC), an embedded processor, or a Field Programmable Gate Array (FPGA). Mesh Software Application 210 and Device Driver 220 may be implemented as instructions executing on one or more programmable data processors, such as central processing units (CPUs). Different versions or configurations of Mesh Software Application 210 may be installed on Mesh Node 200 depending on its role. For example, based on whether Mesh Node 200 is acting as a gateway 120, sequencer 150, or core compute node 140, a different version or configuration of Mesh Software Application 210 may be installed.

While any suitable physical communications link layer may be employed, (including universal serial bus (USB), peripheral component interconnect (PCI) express (PCI-Express or PCI-E), high-definition multi-media interface (HDMI), 10 Gigabit Ethernet (GigE), 40 GigE, 100 GigE, or InfiniBand (IB), over fiber or copper cables), in this example, the Mesh Node 200 has multiple low latency 10 Gigabit Ethernet small form-factor pluggable plus (SFP+) connectors (interfaces) 270-1, 270-2, 270-3, . . . , 270-n, (known collectively as connectors 270). The connectors 270 may be directly connected to other nodes in the point-to-point mesh via dedicated connections 180, connected via shared connections 182, and/or connected to participant devices 130 via a gateway 120, for example. These connectors 270 are electronically coupled in this example to 10 GigE media access (MAC) Cores 260-1, 260-2, 260-3, . . . , 260-n, (known collectively as GigE Cores 260), respectively, which in this embodiment are implemented by Fixed Logic Device 230 to ensure minimal latency. In other embodiments, 10 GigE MAC Cores 260 may be implemented by functionality outside Fixed Logic Device 230, for example, in PCI-E network interface card adapters.

In some embodiments, Fixed Logic Device 230 may also include other components. In the example of FIG. 2, Fixed Logic Device 230 also includes a Fixed Logic 240 component. In some embodiments, fixed Logic component 240 may implement different functionality depending on the role of Mesh Node 200, for example, whether it is a gateway 120, sequencer 150, or core compute node 140. Also included in Fixed Logic Device 230 is Fixed Logic Memory 250, which may be a memory that is accessed with minimal latency by Fixed Logic 240. Fixed Logic Device 230 also includes a PCI-E Core 235, which may implement PCI Express functionality. In this example, PCI Express is used as a conduit mechanism to transfer data between hardware and software, or more specifically, between Fixed Logic Device 240 and the Mesh Software Application 210, via Device Driver 220 over PCI Express Bus 233. However, any suitable data transfer mechanism between hardware and software may be employed, including Direct Memory Access (DMA), shared memory buffers, or memory mapping.

In some embodiments, the Mesh Node 200 may also include other hardware components. For example, depending on its role in the electronic trading system 100, the Mesh Node 200 in some embodiments may also include the High-Resolution Clock 195 (also illustrated in and disclosed in conjunction with FIG. 1D) used in the implementation of high-resolution clock synchronization among nodes in electronic trading system 100. A Dynamic Random-Access Memory (DRAM) 280 may also be included in the Mesh Node 200 as an additional memory in conjunction with the Fixed Logic Memory 250. The DRAM 280 may be any suitable volatile or non-volatile memory, including one or more random-access memory banks, hard disk(s), and solid-state disk(s), and accessed over any suitable memory or storage interface. As disclosed above, the Mesh Node 200 could represent a gateway 120, a sequencer 150, or a core compute node 140 and may be arranged in a point-to-point mesh architecture, such as disclosed above with regard to FIGS. 1A-D, above, and as disclosed with regard to FIG. 3, further below.

In view of the example embodiments discussed in FIGS. 1B-1, 1B-2, 1C, 1D, 1E and FIG. 2, it should be apparent that the point-to-point mesh architecture 172 of the electronic trading system 100 provides for improved latency in a number of ways. In embodiments in which messages are exchanged among nodes in the electronic trading system 100 over direct dedicated connections 180 without traversing a switch, avoiding the switch in and of itself allows for multiple latency related advantages:
a) The time needed for a switch to process a single message (the time interval between a message entering the switch and the message leaving the switch) is eliminated entirely. This switch processing latency is typically around 1.0 microseconds, including buffering time and time for routing messages to the appropriate destination, as specified in the headers of the messages.
b) Two transmission times (the transmission time between the sending node and the switch and the transmission time between the switch and the receiving node) are replaced by a single transmission time for transmitting the message directly between the sending node and the receiving node.
c) Communicating via direct point-to-point connections without a switch also eliminates a requirement to exchange messages within the mesh according to certain established protocols, such as TCP/IP, which may be required by the switch but add processing time overhead even in the sending node and receiving node. The time required for the sending node to perform protocol specific processing, such as forming up TCP/IP headers, calculating checksums, etc., and for the receiving node to also perform analogous protocol specific processing, such as interpreting the TCP/IP headers and verifying checksums amounts to around 0.5 microseconds on each of the sending node and receiving node, for a total of around 1.0 microseconds. This protocol specific overhead can optionally be eliminated in some embodiments of the point-to-point mesh architecture 172 that exchange messages in accordance with one or more custom protocols, rather than specific established protocols required by the switch, such as TCP/IP.
d) Messages may be broadcast perfectly simultaneously to directly connected nodes, and received perfectly simultaneously by the directly connected recipient nodes, as discussed further below. Different messages may also be received perfectly simultaneously from multiple directly connected sender nodes, also as discussed further below.

Latency may be improved in embodiments in which the direct dedicated connections 180 between nodes are implemented via dedicated communications logic and dedicated interfaces, such as GigE MAC Cores 260 and connectors 270, respectively, as discussed in connection with FIG. 2, above. In some such embodiments, each of the GigE MAC Cores 260 handles the message communication between its node and a single other node, and each of the connectors 270 is connected via a dedicated connection 180 to a single other node in the point-to-point mesh architecture 172. For example, considering three nodes in the point-to-point mesh of the embodiment of FIG. 1D (gateway 120-1, core compute node 140-1, and core compute node 140-2), gateway 120-1 is connected via a dedicated connection 180-1-1 to core compute node 140-1, and gateway 120-1 is also connected via a separate dedicated connection 180-1-2 to core compute node 140-2. If each of these three nodes is implemented via the embodiment of FIG. 2, the GigE MAC Core 260-1 and the connector 270-1 on the gateway 120-1 may be used solely for communication with core compute node 140-1, and the GigE MAC Core 260-1 and the connector 270-1 on the core compute node 140-1 may be used solely for communication with the gateway 120-1, over dedicated connection 180-1-1. Similarly, the GigE MAC Core 260-2 and the connector 270-2 on the gateway 120-1 may be used solely for communication with core compute node 140-2, and the GigE MAC Core 260-1 and the connector 270-1 on the core compute node 140-2 may be used solely for communication with the gateway 120-1, over dedicated connection 180-1-2. Thus, according to such embodiments, dedicated compute resources, such as one of the GigE Cores 260 and one of the Connectors 270, is used on each node for communicating with each other node with which it has a dedicated connection 180.

These dedicated compute resources per dedicated connection 180 allow messages to be broadcast perfectly simultaneously by a sending node among other mesh nodes directly connected (e.g., via a dedicated connection 180) to that sending node, particularly when the GigE Cores 260 are implemented in hardware, such as the Fixed Logic Device 230. Conversely, a broadcasted message from the sending node may be received perfectly simultaneously by all the receiving nodes, in which each receiving node has a respective dedicated connection 180 to the sending node, the receiving being implemented by a dedicated connection communications logic and dedicated interface, for each node directly connected to the recipient node. No receiving node is favored, since each receiving node receives the broadcasted message perfectly simultaneously; the internal message latency among different nodes in the mesh should be identical. In addition, a receiving node may perfectly simultaneously receive different messages, each from a different node directly connected to it.

The ability to send and receive multiple messages perfectly simultaneously contrasts with other environments in which communication among servers is done via a switch; such environments typically require the sending and receiving of messages to be serialized. When communication is done via a switch, typically, each server has a single connection (or at times, multiple redundant connections, but which may still be considered a single logical connection) between itself and the switch. In the event a server requires broadcasting a message to multiple other servers in the system, those messages will not actually be sent simultaneously to the switch nor received simultaneously by the switch, but instead will need to be sent/received one after another in serial fashion over the single logical connection between the server and the switch. Similarly, even if it may be possible for the switch to simultaneously receive multiple different messages destined for the same server but originating from different sending servers (because the switch may have a single connection to each of the originating servers), those multiple different messages still need to be serialized by the switch in order to send them one by one over the single logical connection between the switch and the destination server. This serialization of messages required in such environments not only increases the overall latency of the system, but also results in less predictable latency among servers within such a system. For example, if a message needs to be broadcast from a server to fifteen other servers in the system, those fifteen messages need to be serialized as they are sent to the switch, and the latency difference could be significant whether a message destined for a particular destination server happens to be the first versus the fifteenth message in the broadcasted series of messages.

Besides latency advantages that may be gained from the use of dedicated connections 180 that do not require the traversal of a switch, the point-to-point mesh architecture 172 allows for other latency improvements, as well. As discussed above in connection with FIG. 1B-1, a message being sent between two nodes in the point-to-point mesh, such as from the gateway 120-1 to the core compute node 140-1, in order to ensure that the message can be processed throughout the electronic trading system 100 in a deterministic sequence relative to other messages, may be sent via the ordering path 117. As the message traverses through the ordering path 117, it passes through the sequencer 150-1, which marks the message with a unique sequence identifier, producing a sequenced-marked message that the sequencer 150-1 then sends to the destination node (the core compute node 140-1, in this example). With the receipt of the sequence-marked message, the destination node (the core compute node 140-1, in this example), may ensure that the message is processed in the correct deterministic order, as specified by the sequence identifier in the sequence-marked message, relative to other messages (that have also been sequence-marked by the sequencer) in the electronic trading system 100.

As discussed above in connection with FIG. 1B-1, this ordering path 117 may include multiple direct connections: a direct connection between the sending node and the sequencer (such as the direct connection 180-gw1-s1 between the gateway 120-1 and the sequencer 150-1), and also a direct connection between the sequencer and the destination node (such as the direct connection 180-c1-s1 between the sequencer 150-1 and the compute node 140-1). These multiple direct connections comprising the ordering path 117, in some embodiments, do not pass through a switch and may benefit from the latency advantages already discussed above. Nonetheless, in such embodiments, the latency of the ordering path 117 is impacted by the processing time of a message in the sequencer 150-1 (i.e., the time necessary for the sequencer 150-1 to receive the non-sequence-marked (i.e., unsequenced) message, mark it with a sequence identifier, and send the sequence-marked message to the destination) and the transmission time of the message through two direct connections. (That is, the non-sequence-marked version is first sent over a direct connection from the sender node to the sequencer, and then, the sequence-marked version is sent over a separate direct connection from the sequencer to the destination node). Testing shows that this latency impact of the ordering path 117 as compared to a single direct connection is an additional 0.5 to 1.0 microseconds for the ordering path 117, depending on factors, such as whether a custom protocol is used rather than certain established protocols, such as TCP/IP.

Accordingly, as an optimization in order to minimize the possible latency impact of a message's traversing through the ordering path 117, the non-sequence-marked message may also be sent in parallel over the activation link 180-1-1, which may be a single direct connection between the sender node and the destination node, such as the direct connection 180-1-1 between the gateway 120-1 and the sequencer 140-1. Thus, in some embodiments, the non-sequence-marked message may be sent perfectly simultaneously by the sending node (e.g., the gateway 120-1) both to the destination node (e.g., the core compute node 140-1) over the activation link 180-1-1 and, as part of the ordering path 117, to the sequencer 150-1 over the direct connection (e.g., direct connection 180-gw1-s1) between the sending node and the sequencer 150-1. According to such embodiments, the sequencer 150-1 and the destination node (e.g., the core compute node 140-1) may simultaneously receive the non-sequence-marked version of the message, which allows the destination node to activate processing of the non-sequence-marked message immediately upon its receipt. At the same time that the sequence-marked message is being produced by the sequencer 150-1 and transmitted to the destination node, the destination node may, in parallel, start processing the non-sequence-marked message, such processing including loading into faster memory data related to a symbol referenced in the message, building up a preliminary response message, or otherwise commencing a matching function activity for an electronic trade. As discussed above, upon receiving the sequence-marked message, the destination node may complete the processing of the message in accordance with the proper deterministic order (i.e., sequence) as specified by the sequence identifier. By the time the destination node receives the sequence-marked message over the ordering path 117, however, it will already have had the opportunity to perform useful processing of the non-sequence-marked version of the message (e.g., 0.5 to 1.0 microseconds worth of processing time), allowing it to complete the processing of the sequence-marked message more quickly, and produce a response message with corresponding lower latency, than if it had not already received the non-sequence-marked version of the message via the activation link 180-1-1.

Thus, as has been discussed above, the point-to-point mesh architecture (e.g., 102 and 172) provides for improved latency in a number of ways. Through testing, at least some of these latency improvements have been empirically quantified. For example, the latency improvements due to the use of direct connections between nodes, avoiding a switch, amount to a total of at least 1.0 microseconds and, in some cases, up to 3.0 microseconds in each direction (i.e., incoming vs outgoing). In addition, the latency improvements due to the opportunity for a destination node to process a non-sequence-marked message received via the activation link 180-1-1, in parallel with the processing and transmission of the message via the ordering path 117, amount to another 0.5 to 1.0 microseconds in each direction. Therefore, the possible latency improvements in aggregate from the time an incoming message enters the electronic trading system 100 from a participant device 130 via a gateway 120 to the time a corresponding response message is sent to the participant device 130 from the gateway 120 amount to at least 2.5 to 7.0 microseconds. In a latency sensitive application, such as electronic trading, a difference in latency of even microseconds is highly significant. These latency improvements allow some embodiments of the electronic trading system 100 to reliably respond in accordance with a desired response time latency of 5.0 to 7.0 microseconds, which is a marked improvement over prior art trading systems, the best of which currently have a response time latency in the range of 50 to 75 microseconds.

FIG. 3 is a block diagram of another example embodiment of a point-to-point mesh system 302. The point-to-point mesh system 302 includes a plurality of gateways 320, plurality of core compute nodes 340, and the sequencer 350. Each gateway 320-1, 320-2 . . . 320-g of the plurality of gateways 320 is coupled to each core compute node 340-1, 340-2 . . . 340-c of the plurality of core compute nodes 340 via respective first direct connections, namely the first direct connections 380-a. The sequencer 350 is coupled to each gateway of the plurality of gateways 320 via respective second direct connections, namely the second direct connections 380-b, and coupled to each core compute node of the plurality of core compute nodes via respective third direct connections, namely the third direct connections 380-c. Referring to FIGS. 1B-1, 1B-2, 1D, and FIG. 3, the gateway 120-1 may be a given gateway of a plurality of gateways 320 communicatively coupled to each other via a shared gateway network, such as disclosed above with regard to FIG. 1D, or via the direct connections 384a, 384b . . . 384g of FIG. 3. The plurality of gateways 320 includes the gateways 320-1, 320-2, . . . 320-g in the example embodiment. The core compute node 140-1 may be a given core compute node of a plurality of core compute nodes 340 including the core compute nodes 340-1, 340-2, . . . 340-c that may be communicatively coupled to each other via a shared core compute node network, such as disclosed above with regard to FIG. 1D, or via the direct connections 386a, 386b . . . 386c of FIG. 3. It should be understood that a number g of gateways may be the same or different from another number c of core compute nodes in the point-to-point mesh system 302. According to an example embodiment, the sequencer 150-1 may be a given sequencer of a plurality of sequencers communicatively coupled to each other via a shared sequencer network, such as the sequencer-wide shared network 182-s disclosed above with regard to FIG. 1D, or via direct connections, such as the fourth direct connection 482, disclosed below with regard to FIG. 4.

FIG. 4 is a block diagram of another example embodiment of a point-to-point mesh system 402. With reference to FIG. 1B-2 and FIG. 4, the sequencer 150-1 may be a given sequencer of a plurality of sequencers including the sequencer 450-1 and at least one other sequencer 450-2 in the point-to-point mesh system 402.

In the point-to-point mesh system 402, each gateway 420-1, 420-2 . . . 420-g of the plurality of gateways 420 is coupled to each core compute node 440-1, 440-2 . . . 440-c of the plurality of core compute nodes via respective first direct connections, namely the first direct connections 480a. Each gateway of the plurality of gateways 420 is coupled to each sequencer 450-1 . . . 450-2 of the plurality of sequencers via respective second direct connections, namely the second direct connections 480-b-1 and 480-b-2. Each core compute node 440-1, 440-2 . . . 440-c of the plurality of core compute nodes 440 is coupled to each sequencer 450-1 . . . 450-2 of the plurality of sequencers via respective third direct connections, namely the third direct connections 480-c-1 and 480-c-2.

The given sequencer, that is, a particular sequencer of the sequencers 450-1 . . . 450-2, may be a currently active sequencer that is servicing the point-to-point mesh system and each other sequencer of the plurality of sequencers may be standby sequencers waiting to take over as the currently active sequencer. Each sequencer of the plurality of sequencers may be coupled to each other sequencer of the plurality of sequencers via respective fourth direct connections, such as the fourth direct connection 482. Each gateway 420-1, 420-2 . . . 420-g of the plurality of gateways 420 may be further configured to transmit a respective compute-node-destined message (not shown) transmitted therefrom to the given sequencer of the plurality of sequencers 450-1 . . . 450-2. Each core compute node 440-1, 440-2 . . . 440-c of the plurality of core compute nodes 440 is further configured to transmit a respective gateway-destined message (not shown) transmitted therefrom to the given sequencer of the plurality of sequencers 450-1 . . . 450-2. The at least one other sequencer is in a standby state.

The standby state (standby role) may represent a passive state in which the at least one other sequencer is powered on and configured to be in a “listening only” mode in which the at least one sequencer is configured to receive messages but does not transmit messages and is ready to take over as the active sequencer in an event the current active sequencer fails. The currently active sequencer is in an active state (active role) in which it can receive and transmit messages. In general, a standby sequencer is a redundant (backup) sequencer that is powered on, capable of receiving messages, and ready to take over as the active sequencer. Such switchover, that is, from a standby state (role) to an active state (role) may be due to failure of the currently active sequencer or based on a receipt of switchover command issued by a controller (not shown) for another reason, such as a software update being applied to the currently active sequencer for non-limiting example.

The given sequencer (in the active state) may be further configured to transmit the sequence-marked message, such as the sequence-marked message 106′ and sequence-marked response 107′ via each respective fourth direct connection 482 to each other sequencer of the plurality of sequencers 450-1 . . . 450-2 to enable the standby sequencers to be able to take over as the currently active sequencer in an event the currently active sequencer fails, or is no longer designated as the active sequencer for another reason, such as a software update for non-limiting example. It should be understood, however, that the active sequencer, that is, the given sequencer in the active state, does not need to forward the sequenced-marked message to the standby sequencers, that is, the sequencers in the standby state, and could, alternatively, continually broadcast/replicate a journal, also referred to herein as a state log (which would include the sequence information therein) to the standby sequencers, such as disclosed above with regard to FIG. 1D.

The electronic trading system 100 may further comprise a system state log (not shown), such as disclosed above with regard to FIG. 1D. The active sequencer may be configured to transmit the system state log via the shared sequencer network from the active sequencer to at least one other sequencer of the plurality of sequencers. For example, the shared sequencer network may include the fourth direct connection 482 and the system state log may be transmitted from the sequencer 450-1 to the sequencer 450-2 in an event the sequencer 450-1 is the given sequencer that is in the active state.

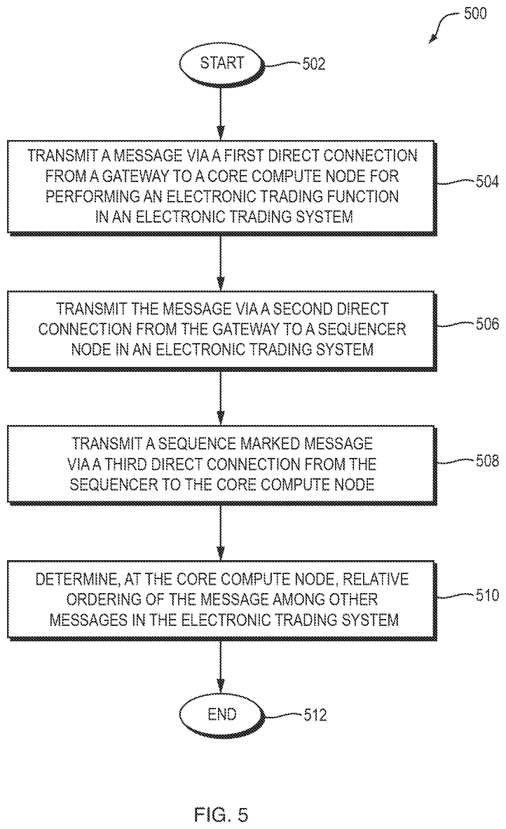

FIG. 5 is a flow diagram 500 of an example embodiment of a method for performing electronic trading. The method begins (502) and transmits a message, representing an electronic trade request with an offer to buy or sell a financial instrument, via a first direct connection from a gateway to a core compute node (504). The message is received, in turn, by the core compute node for performing an electronic trading function in an electronic trading system. The method transmits the message via a second direct connection from the gateway to a sequencer in the electronic trading system (506) and, in turn, transmits a sequence-marked message via a third direct connection from the sequencer to the core compute node (508). The first, second, and third direct connections have respective non-shared bandwidths. The sequencer is interposed between the gateway and core compute node via the second and third direct connections. The sequence-marked message transmitted by the sequencer is a sequenced version of the message transmitted from the gateway via the second direct connection. The sequence-marked message is received, in turn, by the core compute node. The method receives, at the core compute node, other messages from the gateway and receiving sequence-marked versions of the other messages from the sequencer and determines, at the core compute node, relative ordering of the sequence-marked message among the sequence-marked versions of the other messages received by the core compute node in the electronic trading system (510). The core compute node completes the electronic trading matching function for the electronic trade request in accordance with the relative ordering determined. The completing causes the offer to be matched with a counteroffer for the financial instrument enabling an electronic trade of the financial instrument. The method thereafter ends (512) in the example embodiment.

The message may be a gateway message. The method may further comprise receiving an incoming message from a participant device at the gateway. Transmitting the gateway message may include transmitting the gateway message by the gateway in response to receipt of the incoming message by the gateway from the participant device. The sequence-marked message may be a first sequence-marked message. The method may further comprise transmitting the first sequence-marked message via the second direct connection from the sequencer to the gateway. The first sequence-marked message may be received, in turn, by the gateway. The method may further comprise transmitting a core compute node message via the first direct connection from the core compute node to the gateway in response to receipt of the message, transmitting the core compute node message via the third direct connection to the sequencer and, in turn, transmitting a second sequence-marked message via the second direct connection from the sequencer to the gateway. The second sequence-marked message is a sequenced version of the core compute node message. The method may further comprise determining, at the gateway, relative ordering of the second sequence-marked message and sequence-marked versions of other messages sent from the core compute node to the gateway, transmitting an outgoing message to the participant device, the outgoing message transmitted in accordance with the relative ordering determined, and transmitting the second sequence-marked message via the third direct connection from the sequencer to the core compute node.

The gateway may be a given gateway of a plurality of gateways, the core compute node may be a given core compute node of a plurality of core compute nodes, and the method may further comprise transmitting a respective compute-node-destined message from each gateway of the plurality of gateways to all core compute nodes of the plurality of core compute nodes and to the sequencer. The method may further comprise transmitting a respective gateway-destined message from each core compute node of the plurality of core compute nodes to all gateways of the plurality of gateways and to the sequencer and transmitting a respective sequence-marked message to the plurality of gateways and plurality of core compute nodes from the sequencer in response to the respective compute-node-destined message and the respective gateway-destined received at the sequencer.

The sequencer may be a given sequencer among a plurality of sequencers. The method may further comprise transmitting a respective compute-node-destined message from each gateway of the plurality of gateways to the given sequencer, transmitting the respective gateway-destined message from each core compute node of the plurality of core compute nodes to the given sequencer, and transmitting the sequence-marked message from the given sequencer to each other sequencer of the plurality of sequencers.

The method may further comprise receiving a same message at the plurality of core compute nodes, the same message being the respective compute-node-destined message transmitted by the given gateway, generating response messages at the plurality of core compute nodes in response to receipt of the same message, and receiving the response messages, at the given gateway, from among the plurality of core compute nodes. The method may further comprise performing an action at the given gateway based on a given response message of the response messages generated in response to receipt of the same message. The given response message may be first to arrive at the given gateway relative to other response messages of the response messages generated in response to receipt of the same message. The method may further comprise ignoring the other response messages that arrive at the given gateway after the given response message. As such, the “same message” refers to a single message that is broadcast from a single gateway to all compute nodes, so each compute node gets one copy of that single message. Multiple compute nodes may then each respond to that single same message, resulting in multiple functionally equivalent responses being broadcast out to all the gateways, including being received by the given gateway. The gateways including the given gateway can then sort out these multiple functionally equivalent messages on a “first to arrive” basis.

The method may further comprise receiving a plurality of compute-node-destined messages, at the given compute node, from at least two gateways among the plurality of gateways. Each compute-node-destined message of the plurality of compute-node-destined messages may represent a respective version of a same message, the respective version having been input to a respective gateway of the at least two gateways over a respective high availability flow. The method may further comprise performing an action at the given compute node based on a given compute-node-destined message of the plurality of compute-node-destined messages. The given compute-node-destined message may be first to arrive at the given compute node relative to other compute-node-destined messages of the plurality of compute-node-destined messages. The method may further comprise ignoring the other compute-node-destined messages that arrive at the given compute node after the given compute-node-destined message.

The method may further comprise matching trade orders related to a financial instrument at the core compute node based on the electronic trading matching function performed. The method may further comprise maintaining a residual position of the financial instrument on an order book, the residual position being an unmatched amount of the financial instrument resulting from the electronic trading matching function performed.

The method may further comprise synchronizing the gateway, core compute node, and sequencer, based on a clock.

The message may be a gateway message and the method may further comprise serving at least one participant device at the gateway, receiving an incoming message at the gateway, and transmitting the gateway message to the sequencer and core compute node from the gateway in response to receipt of the incoming message at the gateway. The incoming message may be sourced by the at least one participant device and the method may further comprise producing the sequence-marked message by marking the message, or representation thereof, with a unique sequence identifier.

The method may further comprise protecting the first direct connection, second direct connection, and third direct connection, or a subset thereof, via at least one respective redundant direct connection.

The gateway may be a given gateway of a plurality of gateways, the core compute node may be a given core compute node of a plurality of core compute nodes, and the sequencer is a given sequencer of a plurality of sequencers. The method may further comprise enabling the plurality of gateways to communicate via a shared gateway network, enabling the plurality of core compute nodes to communicate via a shared core compute node network, and enabling the plurality of sequencers to communicate via a shared sequencer network or via respective fourth direct connections.

The method may further comprise transmitting a system log via the shared sequencer network from the given sequencer to at least one other sequencer of the plurality of sequencers or storing, by the given sequencer, the system state log in a data store. The data store may be accessible to the plurality of sequencers via the shared sequencer network.

The electronic trading system may be an active electronic trading system. The method may further comprise enabling at least one sequencer of the plurality of sequencers to communicate with a disaster recovery site. The disaster recovery site may include a standby electronic trading system. The standby electronic trading system may be a replica of the active electronic trading system and configured to allow electronic trading to continue in an event the active electronic trading system fails.

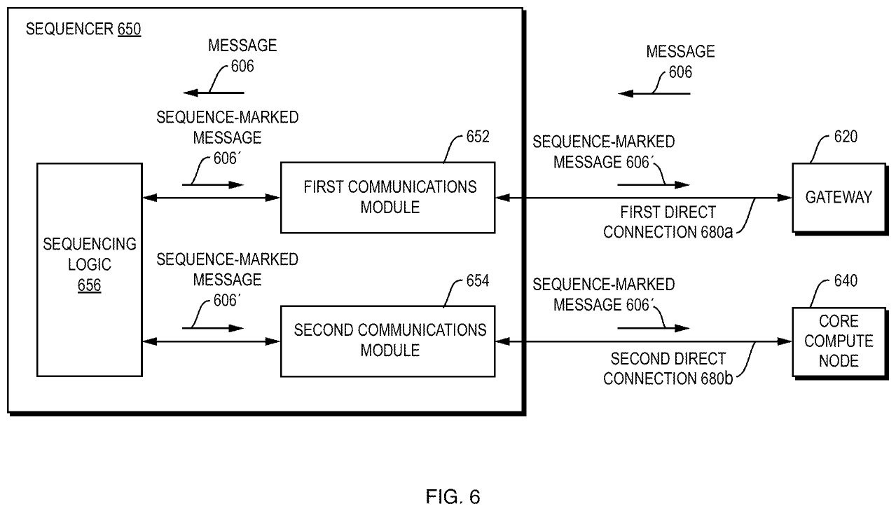

FIG. 6 is a block diagram of an example embodiment of a sequencer 650 of an electronic trading system, such as the electronic trading system 100 disclosed above. In the example embodiment, the sequencer 650 comprises a first communications module 652 configured to communicate directly with a gateway 620 via a first direct connection 680a in a point-to-point mesh system, such as the point-to-point mesh system 102 of the electronic trading system 100, disclosed above. The sequencer 650 further comprises a second communications module 654 configured to communicate directly with a core compute node 640 via a second direct connection 680b in the point-to-point mesh system in the electronic trading system. The sequencer 650 further comprises sequencing logic 656 coupled to the first communications module 652 and second communications module 654.

The sequencing logic 656 is configured to produce a sequence-marked message 606′ by marking a message 606, or representation thereof, with a unique sequence identifier (not shown), the message 606 received by the first communications module 652 or second communications module 654 via the first direct connection 680a or second direct connection 680b, respectively. The sequencing logic 656 is further configured to transmit the sequence-marked message 606′ to the gateway 620 and core compute node 640 via the first communications module 652 and second communications module 654, respectively.

According to an example embodiment, the sequencing logic is a portion of logic of an FPGA, for example, in the Fixed Logic Device 230 of FIG. 2, disclosed above.), or an ASIC. Further, both communications modules 652 and 654 may be implemented in the FPGA, for example, in the 10 GigE MAC Cores 260 disclosed above with regard to FIG. 2.

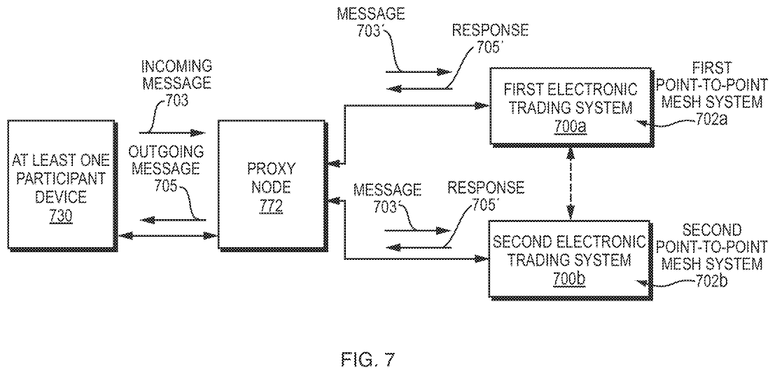

FIG. 7 is a block diagram of another example embodiment of an electronic trading system, such as the electronic trading system 100 of FIG. 1B-1 and FIG. 1B-2, disclosed above. Referring to FIG. 1B-2 and FIG. 7, the gateway 120-1, core compute node 140-1, sequencer 150-1, first direct connection 180-1-1, second direct connection 180-gw1-s1, and third direct connection 180-c1-s1 form a first point-to-point mesh system 702a. The electronic trading system 100 may be a first electronic trading system 700a that is communicatively coupled to a proxy node 772. The proxy node 722 may be further communicatively coupled to at least one participant device 730 and a second electronic trading system 700b. The second electronic trading system 700b may include a second point-to-point mesh system 702b, such as the point-to-point mesh system 102, disclosed above with regard to FIG. 1B-2.

The proxy node 772 is configured to transmit a message 703′ to the first electronic trading system 700a and second electronic trading system 700b in response to receipt of an incoming message 703 from the at least one participant device 730. The first and second electronic trading systems may be configured to generate respective responses to the message transmitted by the proxy node 772. The proxy node 772 may be further configured to send a response, that is, the outgoing message 705, to the at least one participant device 730 in response to receipt of a first arriving response 705′ received from the first electronic trading system 700a or second electronic trading system 700b. The first electronic trading system 700a and second electronic trading system 700b may be synchronized 777, for example, based on a common clock that provides, for example, time-of-day. It should be understood, however, that the first electronic trading system 700a and second electronic trading system 700b are not limited to being synchronized 777 based on a common clock.

According to an example embodiment, a single active/primary sequencer (not shown) for the entire system encompassing both the electronic trading system 700a and electronic trading system 700b may be employed for coordinating sequence numbers between the electronic trading system 700a and electronic trading system 700b. For example, the single active/primary sequencer may coordinate such sequence numbers such that the arriving response 705′ is assigned the same sequence number by both the electronic trading system 700a and electronic trading system 700b, such that the proxy node 772 can properly determine relative ordering of messages. For example, if the single active/primary sequencer active sequencer is in the electronic trading system 700a, that active sequencer may be configured to communicate to the electronic trading system 700b, for example, by communicating to a standby sequencer in the electronic trading system 700b, the sequence number being assigned on a message-by-message basis.

The architectures described above, such as the point-to-point mesh architecture, may be of use in applications other than electronic trading systems. For example, it is possible that it may be used to monitor data streams flowing across a network, to capture packets, decode the packets' raw data, analyze packet content in real time, and provide responses, for applications other than handling securities trade orders.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 2, disclosed above, or equivalents thereof, firmware, custom designed semiconductor logic, Application Specific Integrated Circuits (ASICs), Field Programmable Gate Arrays (FPGAs), a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as one or more random access memor(ies) (RAMs), read only memor(ies) (ROMs), compact disk read-only memor(ies) (CD-ROMs), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

Accordingly, further embodiments may also be implemented in a variety of computer architectures, physical, virtual, cloud computers, and/or some combination thereof, and, thus, the data processing systems described herein are intended for purposes of illustration only and not as a limitation of the embodiments.

While example embodiments have been particularly shown and described, it will be understood by those skilled in the art that various changes in form and details may be made therein without departing from the scope of the embodiments encompassed by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. An electronic trading system, comprising:
a gateway coupled to a core compute node via an activation link and an ordering path, the gateway configured to transmit a message to the core compute node via the activation link and the ordering path,
a sequencer electronically disposed within the ordering path and configured to produce a sequence-marked version of the message, the sequence-marked version including a sequence identifier, the core compute node configured to receive the message and sequence-marked version of the message from the gateway and sequencer, respectively,
the core compute node further configured to (i) commence a matching function activity for an electronic trade responsive to receipt of the message via the activation link, and (ii) responsive to receipt of the sequence-marked version via the ordering path, use the sequence identifier to prioritize completion of the matching function activity toward servicing the electronic trade.

32. The electronic trading system of claim 31, wherein the sequence identifier indicates a deterministic position of the message among a plurality of messages communicated via the activation link and received by the sequencer via the ordering path.

33. The electronic trading system of claim 31, wherein the message and sequence-marked version include common metadata, and further wherein the core compute node is further configured to correlate the message with the sequence-marked version based on the common metadata responsive to receipt of the sequence-marked version via the ordering path.

34. The electronic trading system of claim 31, wherein the message and sequence-marked version include identical user data, the user data associated with an electronic trade request.

35. The electronic trading system of claim 31, wherein the activation link is a first direct connection, wherein the ordering path includes a second direct connection and a third direct connection, wherein the gateway is further configured to transmit the message via the second direct connection to the sequencer which is configured to, in turn, transmit the sequence-marked version to the core compute node via the third direct connection, wherein the message is a gateway message transmitted by the gateway in response to receipt of an incoming message received by the gateway from a participant device, wherein the sequencer is further configured to, in turn, transmit the sequence-marked version via the second direct connection to the gateway, the sequence-marked version received, in turn, by the gateway, wherein the sequence-marked version is a first sequence-marked message, and wherein the core compute node is further configured to:
transmit a core compute node message via the first direct connection to the gateway in response to receiving the gateway message; and
transmit the core compute node message via the third direct connection to the sequencer which is further configured to, in turn, transmit a second sequence-marked message via the second direct connection to the gateway, the second sequence-marked message being a sequenced version of the core compute node message, the gateway further configured to:
determine relative ordering of the second sequence-marked message and sequence-marked versions of other messages sent from the core compute node to the gateway; and
transmit an outgoing message to the participant device, the outgoing message transmitted in accordance with the relative ordering determined, wherein the sequencer is further configured to, in turn, transmit the second sequence-marked message via the third direct connection to the core compute node.

36. The electronic trading system of claim 31, wherein the gateway is a given gateway among a plurality of gateways, wherein the core compute node is a given core compute node among a plurality of core compute nodes, wherein the activation link is a first direct connection, wherein the ordering path includes a second direct connection and third direct connection, and wherein:
each gateway of the plurality of gateways is coupled to each core compute node of the plurality of core compute nodes via respective first direct connections;
the sequencer is coupled to each gateway of the plurality of gateways via respective second direct connections and coupled to each core compute node of the plurality of core compute nodes via respective third direct connections, the plurality of gateways, plurality of core compute nodes, sequencer, and respective direct connections forming at least a portion of a point-to-point mesh system within which:
each gateway of the plurality of gateways is configured to transmit a respective compute-node-destined message transmitted therefrom to all compute nodes of the plurality of core compute nodes and to the sequencer;
each core compute node of the plurality of core compute nodes is configured to transmit a respective gateway-destined message transmitted therefrom to all gateways of the plurality of gateways and to the sequencer; and
the sequencer is further configured to transmit, to the plurality of gateways and plurality of core compute nodes, a respective sequence-marked version of the respective compute-node-destined message or a respective sequenced-marked version of the respective gateway-destined message in response to receipt of the respective compute-node-destined message or the respective gateway-destined message, respectively.

37. The electronic trading system of claim 36, wherein:
the sequencer is a given sequencer of a plurality of sequencers in the point-to-point mesh system;
each gateway of the plurality of gateways is coupled to each sequencer of the plurality of sequencers via respective second direct connections;
each core compute node of the plurality of core compute nodes is coupled to each sequencer of the plurality of sequencers via respective third direct connections;
the given sequencer is a currently active sequencer servicing the point-to-point mesh system and each other sequencer of the plurality of sequencers are standby sequencers waiting to take over as the currently active sequencer;
each sequencer of the plurality of sequencers is coupled to each other sequencer of the plurality of sequencers via a respective fourth direct connection;
each gateway of the plurality of gateways is further configured to transmit a respective compute-node-destined message to the given sequencer of the plurality of sequencers;
each core compute node of the plurality of core compute nodes are further configured to transmit a respective gateway-destined message to the given sequencer of the plurality of sequencers; and
the given sequencer is further configured to transmit the sequence-marked version via each respective fourth direct connection to each other sequencer of the plurality of sequencers to enable the standby sequencers to be able to take over as the currently active sequencer in an event the currently active sequencer fails.

38. The electronic trading system of claim 36, wherein the respective compute-node-destined message transmitted by the given gateway is a same message received by the plurality of core compute nodes, wherein the plurality of core compute nodes are configured to generate response messages in response to receipt of the same message, the response messages received at the given gateway from among the plurality of core compute nodes, and wherein the given gateway is further configured to:
take action based on a given response message of the response messages generated in response to receipt of the same message, the given response message being first to arrive at the given gateway relative to other response messages generated in response to receipt of the same message; and
ignore the other response messages that arrive after the given response message.

39. The electronic trading system of claim 36, wherein a plurality of compute-node-destined messages representing a same message are received from among the plurality of gateways at the given compute node, and wherein the given compute node is further configured to:
take action based on a given compute-node-destined message of the plurality of compute-node destined messages, the given compute-node-destined message being first to arrive at the given compute node relative to other compute-node-destined messages of the plurality of compute-node-messages representing the same message; and
ignore the other compute-node-destined messages that arrive after the given compute-node-destined message.

40. The electronic trading system of claim 31, further comprising an order book accessible by the core compute node and wherein the core compute node is further configured to:
match trade orders related to the financial instrument using an electronic trading matching function; and
maintain a residual position of the financial instrument on the order book, wherein an unmatched amount of the financial instrument results from performing the electronic trading matching function, and wherein the residual position includes the unmatched amount of the financial instrument.

41. The electronic trading system of claim 31, further comprising a clock and wherein the gateway, core compute node, and sequencer, are synchronized based on the clock.

42. The electronic trading system of claim 31, wherein the gateway is further configured to:
serve at least one participant device; and
transmit the message to the sequencer and core compute node in response to receipt of an incoming message at the gateway, the incoming message sourced by the at least one participant device, and wherein the sequencer is further configured to produce the sequence-marked version by marking the message with a unique sequence identifier or by creating a representation of the message received, marking the representation with the unique sequence identifier, and transmitting the representation marked, the representation marked being the sequence-marked version.

43. The electronic trading system of claim 31, wherein the activation link is a first direct connection, wherein the ordering path includes a second direct connect and a third direct connection, and wherein the electronic trading system further comprises at least one respective redundant direct connection for the first direct connect, second direct connection, and third direct connection, or a subset thereof.

44. The electronic trading system of claim 31, wherein:
the gateway is a given gateway of a plurality of gateways communicatively coupled to each other via a shared gateway network;
the core compute node is a given core compute node of a plurality of core compute nodes communicatively coupled to each other via a shared core compute node network; and
the sequencer is a given sequencer of a plurality of sequencers communicatively coupled to each other via a shared sequencer network or via respective direct connections.

45. The electronic trading system of claim 44, further comprising a system state log, wherein the given sequencer is configured to transmit the system state log via the shared sequencer network to at least one other sequencer of the plurality of sequencers or store the system state log in a data store, the data store accessible to the plurality of sequencers via the shared sequencer network.

46. The electronic trading system of claim 44, wherein the electronic trading system is an active electronic trading system and wherein at least one sequencer of the plurality of sequencers is communicatively coupled to a disaster recovery site, the disaster recovery site including a standby electronic trading system, the standby electronic trading system being a replica of the active electronic trading system and configured to allow electronic trading to continue in an event the active electronic trading system fails.

47. The electronic trading system of claim 31, wherein the activation link is a first direct connection, wherein the ordering path includes a second direct connection and a third direct connection, and wherein:
the gateway, core compute node, sequencer, and first, second, and third direct connections form a first point-to-point mesh system;
the electronic trading system is a first electronic trading system communicatively coupled to a proxy node, the proxy node further communicatively coupled to at least one participant device and a second electronic trading system, the second electronic trading system including a second point-to-point mesh system; and
the proxy node is configured to transmit a message to the first and second electronic trading systems in response to receipt of an incoming message from the at least one participant device, the first and second electronic trading systems configured to generate respective responses to the message transmitted by the proxy node, the proxy node further configured to send a response to the at least one participant device in response to receipt of a first arriving response of the respective responses generated and received from the first or second electronic trading systems.

48. A method for performing electronic trading, the method comprising:
transmitting, from a gateway, a message to a core compute node via an activation link and an ordering path, a sequencer electronically disposed within the ordering path;
receiving, at the core compute node, the message and a sequence-marked version of the message from the gateway and sequencer, respectively, the sequence-marked version including a sequence identifier; and
at the core compute node, (i) commencing a matching function activity for an electronic trade responsive to receipt of the message via the activation link, and (ii) responsive to receipt of the sequence-marked version via the ordering path, using the sequence identifier to prioritize completion of the matching function activity toward servicing the electronic trade.

49. The method of claim 48, wherein the sequence identifier indicates a deterministic position of the message among a plurality of messages communicated via the activation link and received by the sequencer via the ordering path.

50. The method of claim 48, wherein the message and sequence-marked version include common metadata and wherein the method further comprises correlating, at the core compute node, the message with the sequence-marked version based on the common metadata responsive to receipt of the sequence-marked version via the ordering path.

51. The method of claim 48, wherein the message and the sequence-marked message include identical user data, the user data associated with an electronic trade request.

52. The method of claim 48, wherein the message is a gateway message, wherein the method further comprises receiving an incoming message from a participant device at the gateway, wherein transmitting the gateway message includes transmitting the gateway message by the gateway in response to receipt of the incoming message by the gateway from the participant device, wherein the sequence-marked version is a first sequence-marked message, wherein the activation link is a first direction connection, wherein the ordering path includes a second direct connection and a third direct connection, and wherein the method further comprises:
transmitting the first sequence-marked message via the second direct connection from the sequencer to the gateway, the first sequence-marked message received, in turn, by the gateway;
transmitting a core compute node message via the first direct connection from the core compute node to the gateway in response to receipt of the message;
transmitting the core compute node message via the third direct connection to the sequencer and, in turn, transmitting a second sequence-marked message via the second direct connection from the sequencer to the gateway, the second sequence-marked message being a sequenced version of the core compute node message;
determining, at the gateway, relative ordering of the second sequence-marked message and sequence-marked versions of other messages sent from the core compute node to the gateway;
transmitting an outgoing message to the participant device, the outgoing message transmitted in accordance with the relative ordering determined; and
transmitting the second sequence-marked message via the third direct connection from the sequencer to the core compute node.

53. The method of claim 48, wherein the gateway is a given gateway of a plurality of gateways, wherein the core compute node is a given core compute node of a plurality of core compute nodes, and wherein the method further comprises:
transmitting a respective compute-node-destined message transmitted from each gateway of the plurality of gateways to all core compute nodes of the plurality of core compute nodes and to the sequencer;
transmitting a respective gateway-destined message transmitted from each core compute node of the plurality of core compute nodes to all gateways of the plurality of gateways and to the sequencer; and
transmitting, from the sequencer to the plurality of gateways and plurality of core compute nodes, a respective sequence-marked version of the respective compute-node-destined message or a respective sequence marked version of the gateway-destined message in response to receipt of the respective compute-node-destined message or gateway-destined message, respectively.

54. The method of claim 53, wherein the sequencer is a given sequencer among a plurality of sequencers and wherein the method further comprises:
transmitting a respective compute-node-destined message transmitted from each gateway of the plurality of gateways to the given sequencer;
transmitting the respective gateway-destined message transmitted from each core compute node of the plurality of core compute nodes to the given sequencer; and
transmitting the sequence-marked version from the given sequencer to each other sequencer of the plurality of sequencers.

55. The method of claim 52, further comprising:
receiving a same message at the plurality of core compute nodes, the same message being the respective compute-node-destined message transmitted by the given gateway;
generating response messages at the plurality of core compute nodes in response to receipt of the same message;
receiving the response messages, at the given gateway, from among the plurality of core compute nodes;
performing an action at the given gateway based on a given response message of the response messages generated in response to receipt of the same message, the given response message being first to arrive at the given gateway relative to other response messages of the response messages generated in response to receipt of the same message; and
ignoring the other response messages that arrive at the given gateway after the given response message.

56. The method of claim 55, further comprising:
receiving a plurality of compute-node-destined messages, at the given compute node, from among the plurality of gateways, the plurality of compute-node-messages representing a same message;
performing an action at the given compute node based on a given compute-node-destined message of the plurality of compute-node-destined messages, the given compute-node-destined message being first to arrive at the given compute node relative to other compute-node-destined messages of the plurality of compute-node-destined message representing the same message; and
ignoring the other compute-node-destined messages that arrive at the given compute node after the given compute-node-destined message.

57. The method of claim 48, wherein the matching function activity includes performing an electronic trading matching function and wherein the method further comprises:
matching trade orders related to a financial instrument at the core compute node based on the electronic trading matching function performed; and
maintaining a residual position of the financial instrument on an order book, the residual position being an unmatched amount of the financial instrument resulting from the electronic trading matching function performed.

58. The method of claim 48, further comprising synchronizing the gateway, core compute node, and sequencer, based on a clock.

59. The method of claim 48, wherein the message is a gateway message and wherein the method further comprises:
serving at least one participant device at the gateway;
receiving an incoming message at the gateway;
transmitting the gateway message to the sequencer and core compute node from the gateway in response to receipt of the incoming message at the gateway, the incoming message sourced by the at least one participant device; and
producing the sequence-marked version by marking the message, or representation thereof, with a unique sequence identifier.

60. The method of claim 48, wherein the activation link is a first direct connection, wherein the ordering path includes a second direct connection and third direct connection, and wherein the method further comprises protecting the first direct connection, second direct connection, and third direct connection, or a subset thereof, via at least one respective redundant direct connection.

61. The method of claim 48, wherein the gateway is a given gateway of a plurality of gateways, wherein the core compute node is a given core compute node of a plurality of core compute nodes, wherein the sequencer is a given sequencer of a plurality of sequencers, and wherein the method further comprises:
enabling the plurality of gateways to communicate via a shared gateway network;
enabling the plurality of core compute nodes to communicate via a shared core compute node network; and
enabling the plurality of sequencers to communicate via a shared sequencer network or via respective direct connections.

62. The method of claim 61, further comprising:
transmitting a system log via the shared sequencer network from the given sequencer to at least one other sequencer of the plurality of sequencers or storing, by the given sequencer, the system state log in a data store, the data store accessible to the plurality of sequencers via the shared sequencer network.

63. The method of claim 61, wherein the electronic trading system is an active electronic trading system and wherein the method further comprises:
enabling at least one sequencer of the plurality of sequencers to communicate with a disaster recovery site, the disaster recovery site including a standby electronic trading system, the standby electronic trading system being a replica of the active electronic trading system and configured to allow electronic trading to continue in an event the active electronic trading system fails.

64. An electronic trading system, comprising:
a gateway, sequencer, and core compute node arranged in a point-to-point mesh topology, the core compute node configured to perform a matching function toward servicing trade requests received from participant devices and introduced into the point-to-point mesh topology via the gateway, the point-to-point mesh topology including a first direct connection, second direct connection, and third direction connection,
the sequencer configured to (i) determine a deterministic order for messages communicated between the gateway and core compute node via the first direct connection and received by the sequencer from the gateway or core compute node via the second or third direct connection, respectively, and (ii) convey position of the messages within the deterministic order by transmitting sequence-marked versions of the messages to the gateway and core compute node via the second and third direct connections, respectively, the messages representing the trade requests or responses thereto.
